(19) United States
(12) Patent Application Publication
(10) Pub. No.: US 2026/0082252 A1
(43) Pub. Date: Mar. 19, 2026

(54) METHODS, ARCHITECTURES, APPARATUSES AND SYSTEMS FOR RETRANSMISSION WHEN NETWORK CODING IS USED

(71) Applicant: InterDigital Patent Holdings, Inc., Wilmington, DE (US)

(72) Inventors: Justin Cray, Philadelphia, PA (US); Faris Alfarhan, Montreal (CA); Martino Freda, Laval (CA); Salah Elhoushy, LaSalle (CA); Ayesha Ijaz, Guildford (GB); Ahmed Almradi, Ipswich (GB); Pascal Adjakple, Great Neck, NY (US); Benoit Pelletier, Roxboro (CA); Ghyslain Pelletier, Montréal (CA)

(21) Appl. No.: 18/884,451

(22) Filed: Sep. 13, 2024

(51) Int. Cl. H04W 24/10; H04W 24/04

(52) U.S. Cl. CPC H04W 24/10; H04W 24/04

(57) ABSTRACT

A method, implemented in a WTRU is described herein. The method may include receiving configuration information associated with one or more network coding generations, determining that at least one condition to trigger a status report request may be satisfied for at least one network coding generation, sending the status report request based on the at least one condition being satisfied for the at least one network coding generation, receiving a status report including information associated with the at least one network coding generation and transmitting at least one network coded packet generated using the at least one network coding generation based on the status report and the configuration information. In various embodiments, the at least one network coded packet may include at least one additional network coded packet to be transmitted for the at least one network coding generation.

### TECHNICAL FIELD

The present disclosure is generally directed to the fields of communications, software and encoding, including methods, architectures, apparatuses, and systems directed to retransmission when network coding is used.

### BACKGROUND

Network coding (NC) is a packet processing function that transforms X input packet(s) into Y output packet(s). A receiver receiving at least X out of Y transmitted coded packets may be able to recover the transmitted information. Embodiments described herein have been designed with the foregoing in mind.

### SUMMARY

Methods, architectures, apparatuses, and systems directed to retransmission when network coding is used are described herein. In an embodiment, a wireless transmit/receive unit (WTRU) is described. The WTRU may include circuitry including any of transmitter, a receiver, a processor, and a memory. The WTRU may be configured to receive configuration information associated with one or more network coding generations. The WTRU may be configured to determine that at least one condition to trigger a status report request may be satisfied for at least one network coding generation. The WTRU may be configured to send the status report request based on the at least one condition being satisfied for the at least one network coding generation. The WTRU may be configured to receive a status report including information associated with the at least one network coding generation and to transmit at least one network coded packet generated using the at least one network coding generation based on the status report and the configuration information. In various embodiments, the at least one network coded packet may include at least one additional network coded packet to be transmitted for the at least one network coding generation.

In an embodiment, a method implemented in a WTRU is described. The method may include receiving configuration information associated with one or more network coding generations, determining that at least one condition to trigger a status report request may be satisfied for at least one network coding generation, sending the status report request based on the at least one condition being satisfied for the at least one network coding generation, receiving a status report including information associated with the at least one network coding generation and transmitting at least one network coded packet generated using the at least one network coding generation based on the status report and the configuration information. In various embodiments, the at least one network coded packet may include at least one additional network coded packet to be transmitted for the at least one network coding generation.

In an embodiment, a network element is described. The network element may include circuitry including any of transmitter, a receiver, a processor, and a memory. The network element may be configured to send configuration information associated with one or more network coding generations. The network element may be configured to receive a plurality of network coded packets associated with at least one network coding generation. The network element may be configured to decode the plurality of network coded packets to recover the at least one network coding generation. The network element may be configured to receive a status report request. The network element may be configured to determine that at least one network coded packet may be missing to recover the at least one network coding generation. The network element may be configured to send a status report indicating a failure to recover the at least one network coding generation and to receive at least one additional network coded packet associated with the at least one network coding generation. In various embodiments, the at least one additional network coded packet may not be a retransmission of a missing network coded packet.

In an embodiment, a method implemented in a network element is described. The method may include sending configuration information associated with one or more network coding generations, receiving a plurality of network coded packets associated with at least one network coding generation, decoding the plurality of network coded packets to recover the at least one network coding generation, receiving a status report request, determining that at least one network coded packet may be missing to recover the at least one network coding generation, sending a status report indicating a failure to recover the at least one network coding generation and receiving at least one additional network coded packet associated with the at least one network coding generation. In various embodiments, the at least one additional network coded packet may not be a retransmission of a missing network coded packet.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example segmented service data unit (SDU) based NC;

FIG. 3 is a diagram illustrating an example cross-SDU based NC;

FIG. 4 is a diagram illustrating an example of NC as a protocol in packet data convergence protocol (PDCP);

FIG. 5 is a diagram illustrating a first sample control message for requesting a status report;

FIG. 6 is a diagram illustrating a second sample control message for requesting a status report;

FIG. 7 is a diagram illustrating a third sample control message for requesting a status report;

FIG. 8 is a diagram illustrating a fourth sample control message for requesting a status report;

FIG. 9 is a diagram illustrating a first example method for requesting feedback from the network (NW);

FIG. 10 is a diagram illustrating a second example method for requesting feedback from the NW;

FIG. 11 is a diagram illustrating an example method for feedback management in presence of network coding, implemented in a WTRU; and

FIG. 12 is a diagram illustrating an example method for feedback management in presence of network coding, implemented in a network element.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

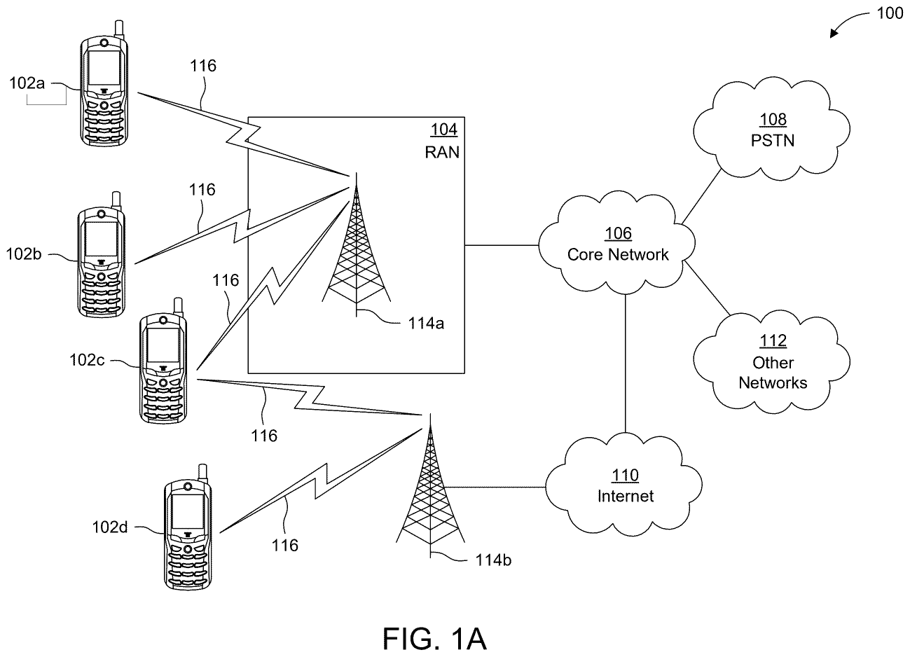

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-third generation partnership project (3GPP) access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “base station”, “network”, “cell”, and “gNB”, collectively “the network” may be used interchangeably to designate any network element such as e.g., a network element acting as a serving base station. Embodiments described herein are not limited to gNBs and are applicable to any other type of base stations.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”. Throughout embodiments described herein, the expression “the WTRU may provide (/be provided) with a set of parameters (/something)” is equivalent or may be used interchangeably with “the WTRU may transmit (/receive) information indicating a set of parameters (/something)”.

In embodiments described herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’.

### Network Coding

5G new radio (NR) supports packet data convergence protocol (PDCP) duplications and transmission of transport blocks (TBs) over multiple transmission and reception points (multi-TRPs) e.g., in support of ultra-reliable and low latency communication services. Considering increasing requirements in terms of various key performance metrics such as spectral efficiency, latency, reliability, data rate and the expectation for a concurrent support of these requirements, the use of redundancy via duplication may not be efficient nor scalable.

Network coding can provide flexible redundancy coding rate for different reliability requirements and flexible split of transmission of coded packets over different transmission paths (e.g., any of frequency diversity, spatial diversity, code diversity) and/or over different time instances (for time domain diversity). In reference to the (e.g., existing) 5G system, network coding may be used to improve efficiency for the support of any of unicast services, multicast broadcast services, sidelink services (e.g., vehicle to everything (V2X) services), enhanced mobile broadband services with the added benefits of better link efficiency, reduced latency, improved reliability, and reduced buffering requirements. Example of deployment scenarios may include carrier aggregation (CA), dual connectivity (DC), integrated access and backhaul (IAB), sidelink including sidelink relay.

Network coding is a packet processing function that transforms X (e.g., a first number of) input packet(s) (which may be referred to herein as source packets) into Y (e.g., a second number of) output packet(s), (which may be referred to herein as coded packet(s)). In an example, X may be greater or equal to two and Y may be greater than or equal to X, with the case X equal to one and Y equal to one being a specific case. The X input packets being coded together may form a network coding generation (referred to herein as a NC generation). NC generation and generation may be used interchangeably in embodiments described herein. A generation may have (e.g., be associated with, identified by) a generation identifier such as a generation sequence number that may be used to associate packets with the generation the packets may be generated from. An input packet may be any of an NC service data unit (SDU) and a segment of an NC SDU. An output packet may be referred to as a NC PDU. Network coding may be seen as a packet processing function transforming X NC SDU(s) or NC SDU-segments into Y NC PDUs, wherein a (e.g., each) NC PDU may be a different linearly independent combination of the NC SDUs or NC SDU-segments that may form the NC generation being encoded into NC PDUs. A first NC PDU generated using the NC generation may be obtained based on a first linear combination of the set of NC SDUs or NC SDU-segments using a first set of coding coefficients, and a second PDU generated using the NC generation may be obtained based on a second linear combination of the set of NC SDUs or NC SDU-segments using a second set of coding coefficients different from the first set of coding coefficients. The first NC PDU (e.g., the first linear combination of the set of NC SDUs) and the second NC PDU (e.g., the second linear combination of the set of NC SDUs) may be linearly independent. The NC PDUs associated with the same generation (e.g., generated using the same generation) may be of same or different characteristics, and may be associated with same or different importance/priority levels. Example of such characteristics may be one or more of: (i) whether the NC PDU is a systematic or a non-systematic NC PDU, (ii) set of coding coefficients used to generate the NC PDU, (iii) type of coding coefficients used to generate the NC PDU, (iv) whether the NC PDU is innovative or non-innovative NC PDU, (v) level of innovativeness (e.g. more-innovative, less-innovative), (vi) whether the NC PDU is redundant or non-redundant NC PDU, (vii) size of a NC SDU or SDU-segment of the generation, for example, in number of bits or octets, (viii) size of the NC PDU, for example, in number of bits or octets, (ix) size of a coding coefficient, for example, in number of bits or octets, etc. In an example, there may be dependencies between NC PDUs of the same generation in the sense that: a) the receiver may (e.g., need to) correctly receive e.g., successfully decode X linearly-independent NC PDUs or more to recover the X NC SDUs; b) how many more NC PDUs or specific NC PDUs may be (e.g., needed to be) received by the receiver to recover the X NC SDUs may depend on the NC PDUs already successfully decoded by the receiver; c) the scheduling of the NC PDUs of the same generation may be associated with (e.g., constrained by) the same overall delay budget.

From the receiver perspective, receiving at least X linearly independent NC PDUs out of the Y transmitted NC PDUs, may allow to recover the transmitted generation e.g., the X NC SDUs or X NC SDU-segments. For example, the receiver may fail to successfully decode some of the received NC PDUs and may be able to recover the NC SDUs or SDU-segments.

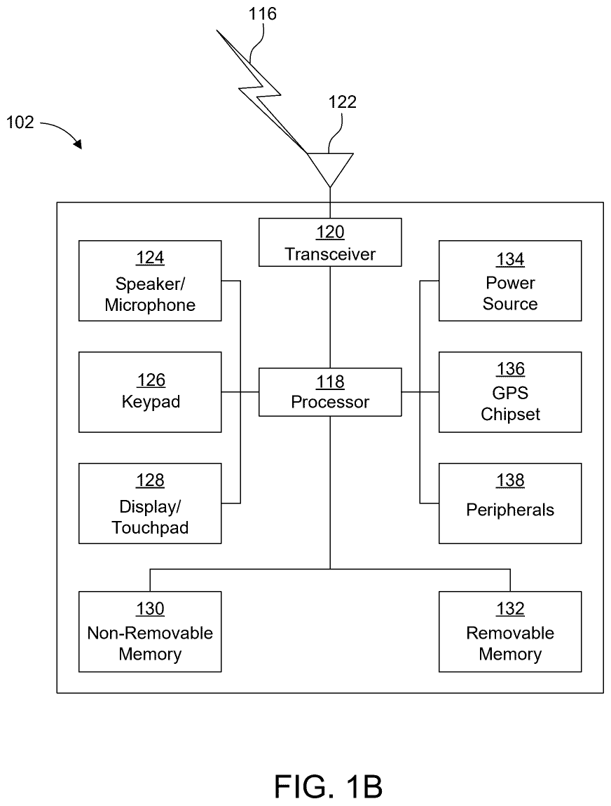

FIG. 2 is a diagram illustrating an example segmented-SDU based NC in which one NC SDU 21 may be segmented and NC may be performed on the segments 211 (e.g., one-to-many mapping).

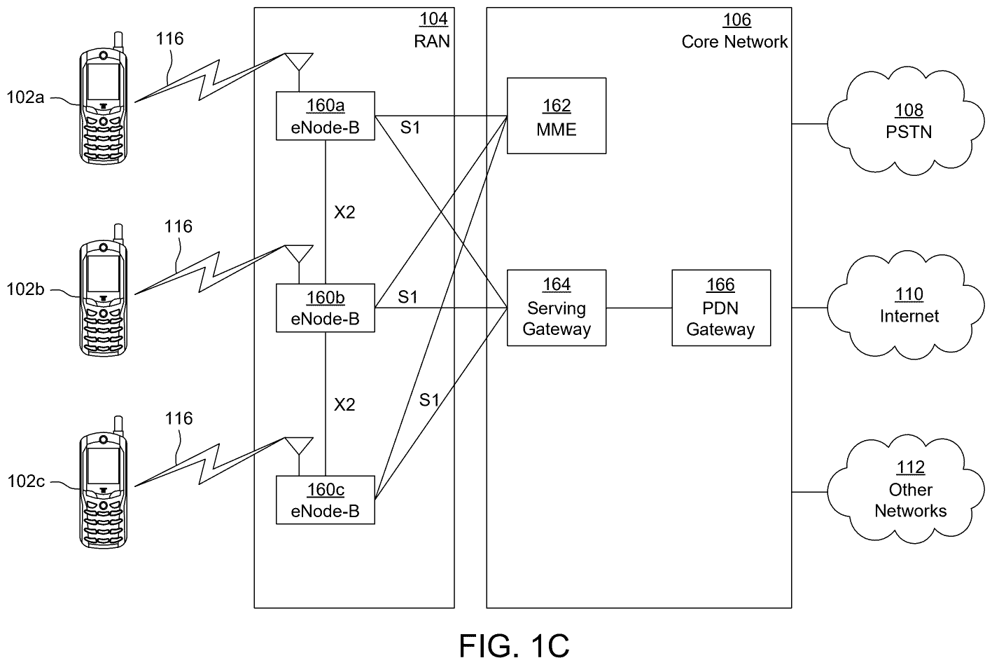

FIG. 3 is a diagram illustrating an example cross-SDU based NC in which NC may be performed using multiple SDUs per NC generation (e.g., many-to-many mapping). Given that NC PDUs from the same generation (or different generations) may have different characteristics, feedback mechanisms may be enhanced based on the dependencies between NC PDUs and the specific propertied for reception success evaluation (e.g., successful reception of X NC PDUs out of Y NC PDUs).

Embodiments are described herein with uplink (UL) as an example of transmission where the WTRU may be provided feedback from the network (e.g., a base station (BS)) via a status report. Embodiments described herein are not limited to uplink transmissions and are also applicable to sidelink transmissions where the WTRU may be provided feedback from the peer WTRU via a status report. Embodiments described herein are not limited to feedback provided via a status report. Any kind of message/signal format for requesting/providing feedback may be applicable to embodiments described herein.

Embodiments are described herein with the example of a NC generation where a) X source packets may be used to generate Y coded packets at the transmitter, and b) the X source packets may be successfully recovered at the receiver upon reception of at least X coded packets. Embodiments described herein may also be applicable to any scenario where the transmitter may transmit Y PDUs (or packet), with the property (e.g., requirement) for the receiver to (e.g., only) successfully receive X PDUs out of the transmitted Y PDUs.

The WTRU may retransmit and/or generate additional NC packets (e.g., based on received status report(s)) to perform error correction to ensure successful delivery of the message.

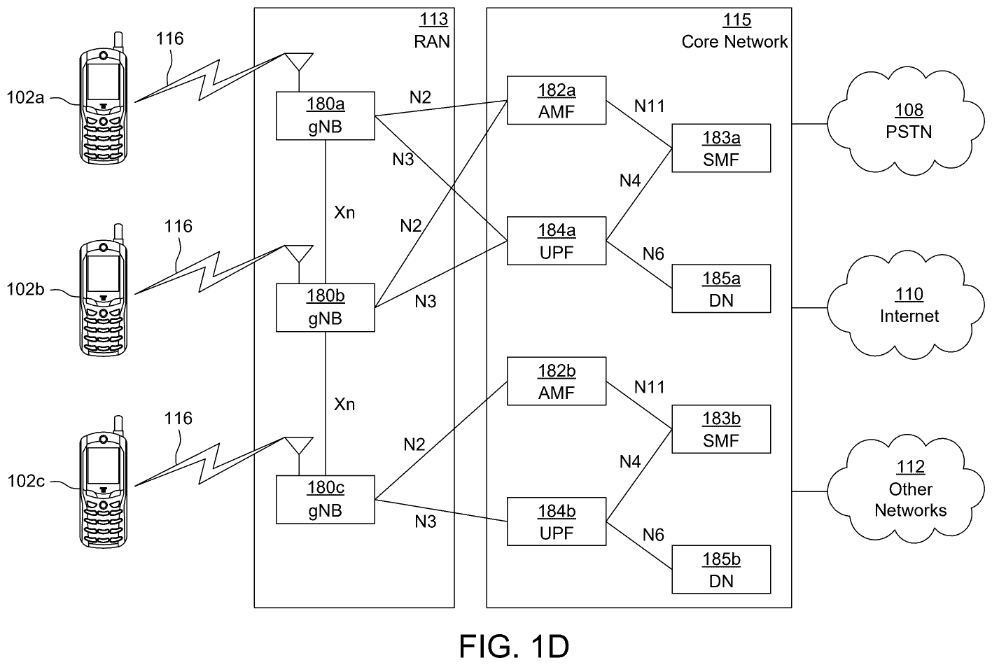

FIG. 4 is a diagram illustrating an example of NC as a protocol in PDCP. The NC encoder 41 may be operating at the PDCP layer transmitter 42 and the NC decoder 43 may be operating at the PDCP layer receiver 44.

Embodiments are described herein with the example of NC as protocol in PDCP. Embodiments described herein may be also applicable to other packet processing methods (such as e.g., any maximum-distance separable codes such as RaptorQ code, Reed-Solomon code, etc.) that may take X SDUs (e.g., as input) and may produce Y PDUs (e.g., as output), where a (e.g., each) PDU may be linearly independent from any of the X SDUs (e.g., each PDU may be a different linearly independent combination of the X SDUs), and at least any X PDUs may allow (e.g., be needed) for the successful recovery of the X SDUs. In embodiments described herein, the input to the coding protocol/function is considered as reliable, e.g., at the receiver, the received PDU may have successfully passed cyclic redundancy check (CRC) check before being processed by the coding protocol/function located in a protocol that may be post-CRC-check processing (e.g. above hybrid automatic repeat request (HARQ), including the application layer). In embodiments described herein, network coding may be applied to packets that may have already been processed through network coding e.g., NC SDUs may be network coded packets e.g. for scenarios with recoding where network coding may be applied at more than one network element located in the processing path of a packet.

Embodiments are described herein with the example of the NC feedback/retransmission protocols being implemented in the radio link control (RLC) and/or PDCP layer(s). Embodiments described herein are not limited to RLC/PDCP based feedback/retransmission and are applicable to any feedback/retransmission protocols when NC may be used and may be utilized in any protocol layer.

In embodiments described herein, the term NC PDU header of an NC PDU may be used in reference to a header with information specific to the NC protocol that may generate the NC PDU, or a header with information regarding any other protocol that may implement NC and/or that may be part of the upper/lower layer protocols relative to the protocol implementing NC.

Implementing network coding above HARQ, for example, in PDCP (as shown in FIG. 4), may increase the status report overhead, and overall transmission delay based on a larger number (e.g., Y) of packets being transmitted (e.g., Y≥X). Network coding may benefit from a feedback mechanism to further enhance performance if feedback delay is acceptable for the application delay requirement. Embodiments described herein may enable enhancements for reduction of any of the status report overhead, the retransmission overhead and the overall transmission delay.

Embodiments described herein address how a receiving node may request status reports from the BS and may perform retransmission to reduce NC PDU retransmission overhead, improve cell capacity and meet the delay budget.

### Overview of Retransmission Method for NC PDUs

In an example, a WTRU may determine when to request a status report based on any of NC PDU transmission and one or more (e.g., new) conditions e.g., associated with NC configuration, where the one or more (e.g., new) conditions may be based on the transmit buffer state and number of generations transmitted. Based on a received status report and NC configuration the WTRU may (e.g., determine to) perform one or more of the following examples of operations.

In a first example of operation, based on a received status report and e.g., NC configuration, the WTRU may flush buffers for NC PDUs generated from a generation of NC SDUs reported as successfully recovered and may discard related SDUs and PDUs from lower layer buffers.

In a second example of operation, based on a received status report and e.g., NC configuration, the WTRU may transmit M additional NC PDUs (e.g., not previously transmitted), where M may be the number of NC PDUs reported as to be received (e.g., required) for a successful recovery of NC SDUs that may form the NC generation. The WTRU may flush buffers for previously transmitted NC PDUs.

In a third example of operation, based on a received status report and e.g., NC configuration, the WTRU may transmit one or more NC PDUs wherein the coding coefficients used to generate the one or more NC PDUs may be coding coefficients recommended (e.g., indicated) by the receiver in the status report.

In a fourth example of operation, based on a received status report and e.g., NC configuration, the WTRU may update network coding parameters (e.g., code rate) based on coding parameters recommended (e.g., indicated) by the receiver in the status report.

In an example, the WTRU may be configured with one or more of (i) a NC code rate, (ii) a lower bound (e.g., minimum) number of NC PDUs (e.g., required) to decode the NC SDUs of the NC Generation (referred to herein as X), (iii) a (e.g., total) number of permitted retransmissions/additional transmissions of NC PDUs per generation, and (iv) a parameter indicating the number of generations between triggers of polls (e.g., status report requests). For example, the WTRU may receive configuration information indicating any of (i) a network coding code rate, (ii) a number of network coded packets to be used to recover a network coding generation, (iii) an upper bound (e.g., maximum) number of transmissions of network coded packets per network coding generation, and (iv) a number of network coding generations between triggers of status report requests. For example, the upper bound (e.g., maximum) number of transmissions of network coded packets may comprise any of an upper bound (e.g., maximum) number of retransmissions of network coded packets and an upper bound (e.g., maximum) number of transmissions of additional network coded packets.

In an example, the WTRU may generate a NC PDU. If the NC PDU is in the transmitting window, the WTRU may transmit the NC PDU.

In an example, the WTRU may evaluate one or more conditions to trigger a status report request. In a first example, the WTRU may send a status report request after a (e.g., configured) number of generations may have been transmitted since the last status report request may have been requested. In a second example, the WTRU may send the status report request based on (e.g., all) PDUs generated using one or more NC generations being sent and e.g., no further PDUs being generated (based on the NC code rate).

In an example, the WTRU may determine that one or more NC-specific conditions to send (e.g., trigger) a status report request may be met and may send a status report request. For example, the status report request may include an indication of which generation(s) may be (e.g., to be) included in the status report. For example, the status report request may include an indication of whether the number of missing and/or extra NC PDUs for a generation may be indicated (e.g., requested, specified). For example, the status report request may include an indication of whether the number of NC PDUs of a (e.g., certain) characteristic received for a generation may be indicated (e.g., requested, specified).

In an example, the WTRU may receive a status report from the BS and may perform one or more of (a) transmit M additional NC PDUs (not previously transmitted), where M may be the number of NC PDUs reported as to be received (e.g., required) for a successful recovery of NC SDUs that may form the NC generation and remove previously transmitted NC PDUs from the retransmission buffer, (b) transmit one or more NC PDUs of one or more NC PDU characteristics, wherein the one or more NC PDU characteristics may be the NC PDU characteristics indicated (e.g., recommended) by the receiver in the status report, (c) update network coding parameters (e.g., code rate) based on coding parameters indicated (e.g., recommended) by the receiver in the status report, and (d) if the NC generation with the smallest generation identifier or generation sequence number is acknowledged, update the lower edge of the transmitting window to be the first NC PDU of the next generation to be recovered.

### Terminology

In embodiments described herein, systematic coding may refer to a coding technique where source symbols (or source packets) may be part of the output coded symbols (or coded packets) e.g., output from the encoding operation. Systematic coding may be used to generate coded packets comprising one or more systematic packets e.g., systematic NC PDU, and one or more non-systematic packets e.g., non-systematic NC PDUs. A packet may comprise one or more symbols, and a symbol may comprise one or more bits.

In embodiments described herein, a systematic NC PDU may refer to a NC PDU generated using (e.g., only) a singular NC SDU from the generation.

In embodiments described herein, a non-systematic NC PDU may refer to a NC PDU that may not be a systematic NC PDU.

In embodiments described herein, the WTRU being “configured with” may refer to the scenario where the WTRU may receive (e.g., information indicating) a configuration from the NW (any of BS, gNB, other WTRU, etc.). For the case where the WTRU may receive (e.g., information indicating) the configuration from a gNB, the WTRU may receive a (e.g., dedicated) radio resource control (RRC) configuration or a system information block (SIB) from the gNB. For the case where the WTRU may receive (e.g., information indicating) the configuration from another network element, the WTRU may receive (e.g., information indicating) the configuration via sidelink communication (e.g., PC5 RRC). The WTRU being “configured” may also refer to the scenario where the WTRU may be hard coded to perform the action e.g. via standard specifications.

In embodiments described herein, an innovative packet/NC PDU may refer to a coded packet that when received may be useful for decoding the generation e.g., by increasing the rank of the generator matrix used to generate the NC PDUs. An innovative NC PDU may be formed with coefficients that may be linearly independent from coefficients used to generate other NC PDUs generated using the same generation of NC SDUs. In embodiments described herein, the term “innovative PDU” in the context of a transmitter may refer to an NC PDU that may be linearly independent from NC PDUs which were previously transmitted/selected for transmission. In embodiments described herein, the term “innovative PDU” in the context of a receiver may refer to an NC PDU that may be linearly independent from NC PDUs which were previously received. In embodiments described herein the terms NC PDU and network coded packets may be used interchangeably.

In embodiments described herein, a level of innovation may refer to a usefulness of the packet when decoding a generation of packets. For example, some packets may (e.g., only) enable the decoding of a small amount of source packets and others may enable the decoding of a larger amount of source packets. In embodiments described herein, the term “more-innovative” may refer to an NC PDU including information about a larger number of source packets e.g., NC SDUs compared to a “less-innovative” NC PDU. In an example, a first NC PDU may be more innovative than a second NC PDU, if the first NC-PDU is coded as a linearly independent combination of a first number (K1) of NC SDUs, the second NC-PDU is coded as a linearly independent combination of a second number (K2) of NC SDUs, and the first number K1 is greater than the second number K2. In another example, a threshold referred to herein a K_innovative may be used. A first NC PDU may be more innovative if the first NC PDU is coded as a linearly independent combination of at least K_innovative NC SDUs. The term “less-innovative NC PDU” may refer to a NC PDU that may enable decoding of a smaller amount of NC SDUs compared to a more-innovative NC PDU. For example, a first NC PDU may be less innovative than a second NC PDU, if the first NC-PDU is coded as a linearly independent combination of a first number (K1) of NC SDUs, the second NC-PDU is coded as a linearly independent combination of a second number (K2) of NC SDUs, and the first number K1 is smaller than the second number K2. In another example, a first NC PDU is less innovative if the first NC-PDU is coded as a linearly independent combination of less than K_innovative NC SDUs.

In embodiments described herein, a current NC generation may refer to the NC generation whose associated NC PDUs may have been transmitted using previously scheduled resources and the WTRU may await the feedback for its NC PDUs.

In embodiments described herein, a generation size may refer to a number of NC SDUs that may form a generation.

In embodiments described herein, a code rate (or information rate) may refer to a ratio of the number of input packet(s) e.g., the generation size to the number of output packet e.g., X/Y.

In embodiments described herein, a codeword may refer to a set of NC PDUs for a (e.g., given) code rate.

In embodiments described herein, a fixed code rate may refer to an NC scheme where a code rate may be fixed or pre-defined. The source NC SDUs may be recovered from the codeword or not recovered at the receiver based on the NC PDUs generated for the code rate, and no additional NC PDU may be transmitted (by the transmitter) or expected to be received (at the receiver) beyond the NC PDUs generated based on the fixed code rate. A specific case of fixed rate NC may be the case where (e.g., all) the generated NC PDU may be transmitted with no expectation/use at the transmitter of a feedback from the receiver indicating whether or not the NC SDUs of the generation may have been recovered.

In embodiments described herein, variable code rates may refer to an NC scheme where one or more code rates may be used in support of the recovery of the NC SDU that may form a generation. For example, the transmitter may transmit NC PDUs according to one or more code rates, up to an upper bound (e.g., maximum) number of potential code rates, or until the recovery by the receiver of the NC SDU that may form a generation.

In embodiments described herein, a rate less code may refer to an NC scheme where an unlimited number of code rates may be used in support of the recovery of the NC SDUs that may form a generation. For example, the transmitter may transmit NC PDUs according to one or more code rates, until the recovery by the receiver of the NC SDU that may form a generation.

In embodiments described herein, adaptive network coding may refer to a network coding scheme that may enable dynamic control, and adaptation of network coding operation over lossy channels by e.g., configuring and adapting coding parameters (e.g., any of generation, generation size, code rate) to meet the (e.g., instantaneous) delay-throughput-reliability requirements according to the radio condition changes (e.g., the channel variation) over time, accounting for the possibly loss of degree of freedom due to erasures (e.g., packet drops) or transmission errors (e.g., bit errors during transmission). In embodiments described herein, a feedback-based network coding scheme may be one form of adaptive network coding where the transmitter may adapt network coding operation based on feedback (e.g., successful decoding or failed decoding) from peer or remote network element.

In embodiments described herein, a retransmission may refer to a transmission of a NC PDU generated from a generation that a previously sent NC PDU with the same coefficients may have been generated from.

In embodiments described herein, an additional transmission may refer to a transmission of a NC PDU generated from a generation that a previously sent NC PDU with different coefficients may have been generated from.

In embodiments described herein, a common delay budget may refer to a same delay budget shared by (e.g., all) NC-PDUs of a same generation. Since NC PDUs may be used to recover the NC SDUs to form a generation, the NC PDUs may have the same (common) delay budget as the NC SDUs used to form the generation. (E.g., all) NC PDUs generated from the same generation may have the same delay budget.

### NC Configuration

A WTRU receiving data from the NW may be configured with a NC configuration from the NW. For example, the WTRU may receive configuration information associated with one or more network coding generations. In an example, the NC configuration may be configured (e.g., indicated) by any of a RRC message, downlink control information (DCI), a MAC control element (CE), a layer one and/or layer two signal. In an example, the NC configuration may be pre-defined e.g., in the specification.

The NC configuration may contain one or more parameters according to any of the following examples.

In an example, the NC configuration may include a parameter indicating the number of NC SDUs per NC generation (X).

In an example, the NC configuration may include a parameter indicating the number of NC PDUs expected to be transmitted per NC generation (Y).

In an example, the NC configuration may include a parameter indicating a code rate. For example, fixed NC code rate may be used. In one example, the code rate parameter may include a ratio X/Y. In another example, the code rate parameter may include the numbers X and/or Y.

In an example, the NC configuration may include a parameter indicating the method of retransmission to be used (e.g., retransmit NC PDUs, send additional/newly generated NC PDUs, etc.)

In an example, the NC configuration may include a parameter indicating the upper bound (e.g., maximum) permitted number of retransmissions/additional transmissions of NC PDUs per generation.

In an example, the NC configuration may include a parameter indicating the number of generations between requests for a status report from the NW.

In an example, the NC configuration may include a parameter indicating a number of generations transmitted and/or generated within a (e.g., certain) time window to trigger a status report request.

In an example, the NC configuration may include a parameter indicating a number of NC PDUs transmitted and/or generated within a (e.g., certain) time window to trigger a status report request.

In an example, the NC configuration may include a parameter indicating one or more method(s) for requesting a status report as described herein.

### Methods for Requesting a Status Report

The WTRU may be configured with one or more methods for requesting a status report. The different methods may include requests for specific content (e.g., to be included) in the status report.

In an example, the WTRU may request a status report by including an indication in the header of a data PDU and/or based on an independent control signaling method such as a MAC CE.

### Request Status Report via Control Signaling

In one example, the WTRU may request the status report via control signaling that may not be associated with any data packets.

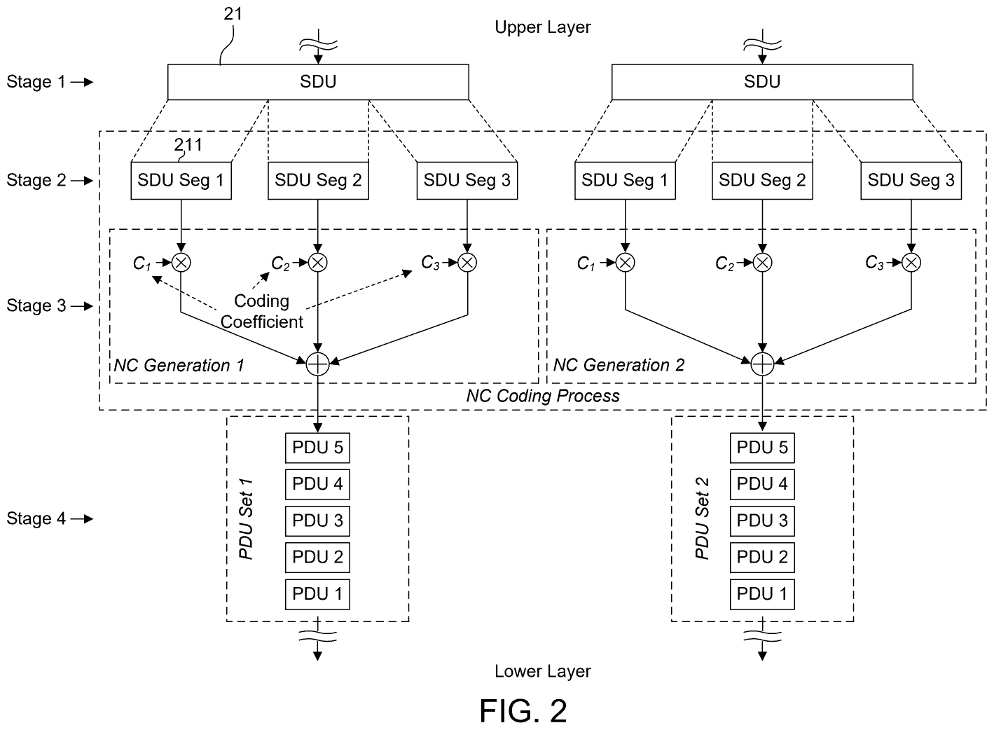

FIG. 5 is a diagram illustrating a sample control message for requesting a status report. As shown at 51, the first two bits may (e.g., be used to) indicate the status report request (poll) format. As shown at 53, the third bit of the control message may be used as a flag bit or poll bit to indicate the request.

### Request Status Report With Information About Generations

In one example, the WTRU may request a status report to contain (e.g., indicate) the number of received packets for (e.g., certain) generation(s).

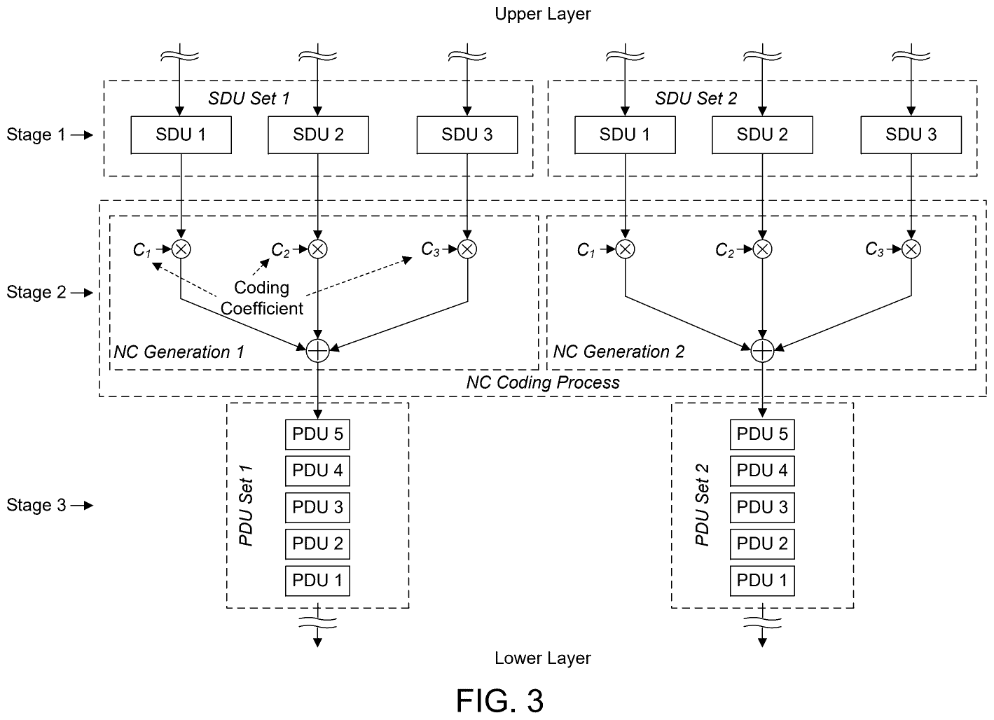

FIG. 6 is diagram illustrating a sample control message for requesting a status report to indicate which NC generation may be to be included in the report. For example, the status report request may indicate at least one network coding generation for which information may be to be included in the status report. As shown at 61, the first two bits may (e.g., be used to) indicate the status report request (poll) format. As shown at 63, the third bit may be used as a flag bit or poll bit to indicate the request. As shown at 64, the next five bits may indicate a generation identifier (referred to as GEN ID), indicating for which generation the status report may indicate the number of received/missing NC PDUs.

### Request Status Report With the Number of Missing or Extra NC-PDUs for a Generation

In one example the WTRU may request the status report of one or more generations to adjust the NC configuration. The WTRU may request a status report to (e.g., indicate) contain (e.g., only) the number of received packets for generations where more than X NC PDUs may have been received or for generations where less than X NC PDUs may have been received. For example, the status report request may indicate if a number of missing network coded packets may be to be reported for at least one unrecovered network coding generation. For example, the status report request may indicate if a number of extra network coded packets may be to be reported for at least one recovered network coding generation, wherein the extra network coded packets may have been received in addition to the network coded packets used for recovering the at least one recovered network coding generation.

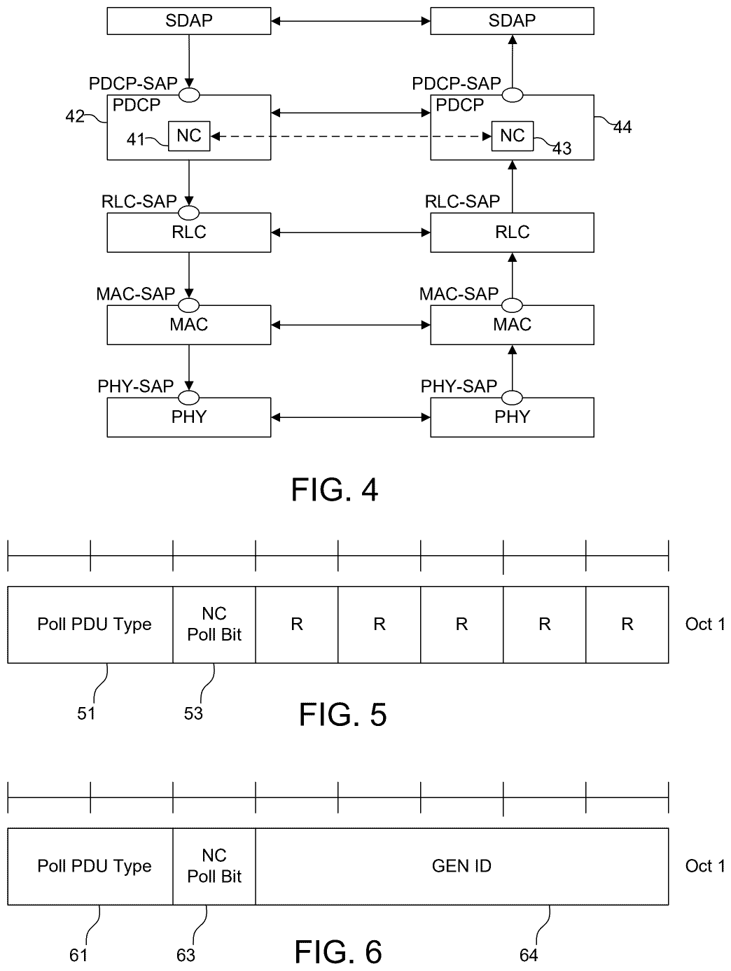

FIG. 7 is a diagram illustrating a sample control message for requesting a status report to indicate whether there were missing or extra NC-PDUs received for the NC generations. For example, the status report request may indicate a characteristic for which a number of received network coded packets may be to be reported for at least one network coding generation. As shown at 71, the first two bits may (e.g., be used to) indicate the status report request (poll) format. As shown at 73, the third bit of the MAC CE may be used as a flag bit or poll bit to indicate the request. As shown at 74, the fourth bit may indicate whether to report the number of missing NC PDUs for the generations (e.g., being non-acknowledged) or the number of extra NC PDUs for the generations that may have been acknowledged where extra NC PDUs may have been received.

### Request Status Report With the Number of a Characteristic for a Generation

In one example, the WTRU may request a status report to contain (e.g., indicate) the number of received packets for (e.g., certain) generation(s).

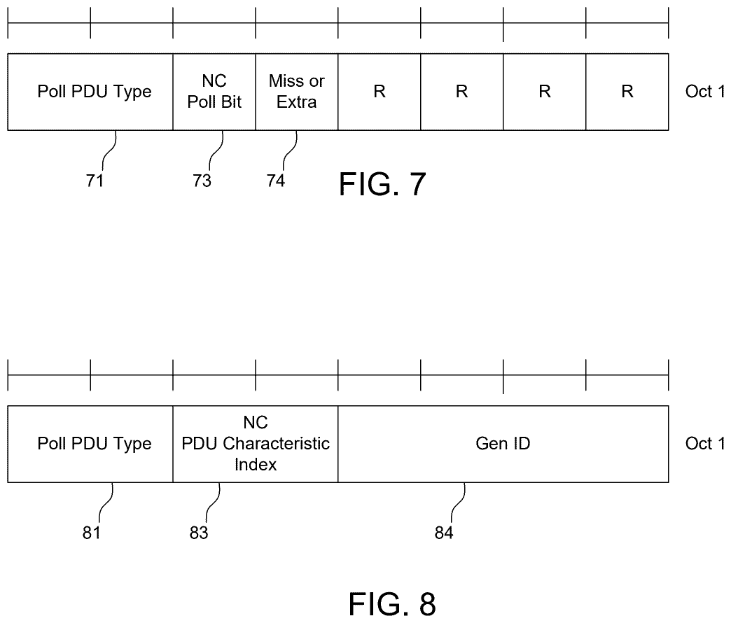

FIG. 8 is a diagram illustrating a sample control message for requesting a status report indicating which NC generation to include in the report and indicting which NC PDU characteristic to include in the NC PDU count indicated for a (e.g., each) generation. As shown at 81, the first two bits may (e.g., be used to) indicate the status report request (poll), As shown at 83, the third and fourth bit may (e.g., be used to) indicate the index of an NC PDU characteristic (any of systematic, non-systematic, high importance, etc.). As shown at 84, the next four bits may indicate a generation identifier (referred to as GEN ID) indicating for which generation the status report may indicate the number of received NC PDUs.

In an example, the NC configuration may include a radio bearer/a PDCP specific configuration. For example, for different PDCP entities/radio bearers configured with the NC protocol respectively, the NW may provide individual NC configurations for (e.g., each of) the configured NC protocols.

In an example, the information described here above in the sample control messages may be included in the header of a data PDU.

In embodiments described herein, the sizes of the fields (number of bits) are described as non-limiting examples. Other sizes of fields are applicable to embodiments described herein.

### WTRU Procedures for Requesting a Status Report

WTRU procedures for requesting a status report are described herein.

In embodiments described herein the terms “condition” and “trigger” may be used interchangeably.

### Status Report Triggers

Status report triggers are described herein. In an example, the WTRU may determine whether at least one condition to trigger a status report request may be satisfied for at least one network coding generation. The WTRU may send the status report request based on the at least one condition being satisfied for the at least one network coding generation.

### First Trigger: After a Number of Generations

In an example, at least one condition to trigger the status report request may be satisfied in a case where a number of network coding generations transmitted since a previous status report may have been requested, is above a threshold.

In an example, the WTRU may request the status report (e.g., to be received) after a configured number of generations may have been transmitted since the last status report may have been requested. The WTRU may maintain, for example, a counter of the number of NC generations that may have been transmitted since the last status report may have been requested.

In a first example, the WTRU may request a status report from the BS after N generations may have been transmitted (at least X NC PDUs per generation may have been transmitted) by the WTRU where N may be a threshold number e.g., configured by the NW. For example, in the case where the WTRU performs the retransmission/additional transmission functions in the RLC layer, the WTRU may transmit a RLC poll bit after N generations may have been transmitted (at least X RLC SDUs per generation being transmitted including (e.g., all) segments of segmented RLC SDUs) by the WTRU where N may be a threshold number e.g., configured by the NW. For example, in the case where the WTRU performs the retransmission/additional transmission functions in the PDCP layer, the WTRU may request a PDCP status report from its peer PDCP entity after N generations may have been transmitted (at least X PDCP PDUs per generation being transmitted) by the WTRU, where N may be a threshold number e.g., configured by the NW.

In a second example, the WTRU may request a status report from the BS after N generations may have been transmitted (Y NC PDUs per generation being transmitted) by the WTRU where N may be a threshold number e.g., configured by the NW. For example, in the case where the WTRU performs the retransmission/additional transmission functions in the RLC layer, the WTRU may transmit a RLC poll bit after N generations may have been transmitted (Y RLC SDUs per generation being transmitted including (e.g., all) segments of segmented RLC SDUs) by the WTRU, where N may be a threshold number e.g., configured by the NW. For example, in the case where the WTRU performs the retransmission/additional transmission functions in the PDCP layer, the WTRU may request a PDCP status report from its peer PDCP entity after N generations may have been transmitted (Y PDCP PDUs per generation were transmitted) by the WTRU, where N may be a threshold number e.g., configured by the NW.

In another example, the WTRU may request a status report based on the number of transmitted NC PDUs (e.g., regardless of what generation they belong to) for which a Poll has not been triggered. For example, the WTRU may use a counter, which may be referred to as NC PDU_Without_Poll that may be initiated to zero, and incremented after an NC PDU may be transmitted. The WTRU may be configured with PollNC_PDU that may be used to trigger a status report. In this case, the WTRU may request a status report if the number of transmitted NC PDUs (e.g., regardless of what generation they belong to) for which a Poll may not have been triggered is greater than or equal to PollNC_PDU, e.g., when NC PDU_Without_Poll≥PollNC_PDU.

### Second Trigger: When Transmit Buffer is Empty and NC PDUs Not to be Generated per the NC Code Rate

In an example, at least one condition to trigger the status report request may be satisfied in a case where (e.g., all) network coded packets generated using the one or more network coding generations have been transmitted. In one example, the WTRU may request the status report after (e.g., once) the transmit buffer may be empty and no further NC PDUs may be generated as per the NC code rate for (e.g., all) generations being transmitted.

In an example, the WTRU may request a status report from the BS after Y NC PDUs may have been transmitted from all current generations and the transmit buffer may be empty. For example, in the case where the WTRU performs the retransmission/additional transmission functions in the RLC layer, the WTRU may transmit a RLC poll bit after Y RLC SDUs (including the redundant RLC SDUs and including (e.g., all) segments of segmented RLC SDUs) in the buffer may have been transmitted for (e.g., all) current generations and the transmit buffer may be empty. For example, in the case where the WTRU performs the retransmission/additional transmission functions in the PDCP layer, the WTRU may transmit a request for a PDCP status report from its peer PDCP entity after Y PDCP PDUs (including the redundant PDCP PDUs) may have been transmitted for (e.g., all) current generations and the transmit buffer may be empty.

### Third Trigger: Send a Status Report Request Based on Receiver Feedback

In an example, the WTRU may request a status report based on information received from the NW in a previous status report. For example, the WTRU may request a status report based on one or more of (i) the non-acknowledged NC generation(s), (ii) the number of NC PDUs that may be reported as expected (e.g., needed) for the receiver to recover the NC generation, etc.

In an example, two or more RLC entities may be associated with the same PDCP entity and may transmit NC PDUs belonging to the same generation. The WTRU may request a status report from a peer RLC entity based on the received status report from a different RLC entity.

In a first example, the WTRU may request a status report from a peer RLC entity to which non-systematic NC PDUs may have been transmitted if the WTRU received a status report from a different RLC entity to which systematic NC PDUs may have been transmitted, the received status report indicating that there may be one or more missing systematic NC PDUs.

In a second example, the WTRU may request a status report from a peer RLC entity to which more-innovative NC PDUs may have been transmitted if the WTRU received a status report from a different RLC entity indicating there may be one or more missing less-innovative NC PDUs.

In a third example, the WTRU may request a status report from a peer RLC entity to which redundant NC PDUs may have been transmitted if the WTRU received a status report from a different entity indicating there may be one or more missing NC PDUs.

### Fourth Trigger: Send a Status Report Request to Meet the NC PDU's Delay Budget

In an example, the at least one condition to trigger the status report request may be satisfied in a case where a delay budget for the at least one network coding generation is less than a time bound.

In one example, the WTRU may request the status report based on one or more NC PDUs in the transmit buffer having a delay budget expiring in a time bound e.g., configured by the NW. For example, in the case where the WTRU performs the retransmission/additional transmission functions in the RLC layer, the WTRU may transmit a RLC poll bit if one or more RLC PDUs have a delay budget less than a time bound e.g., configured by the NW. For example, in the case where the WTRU performs the retransmission/additional transmission functions in the PDCP layer, the WTRU may transmit a request for a PDCP status report from its peer PDCP entity if one or more PDCP PDUs have a delay budget less than a time bound e.g., configured by the NW.

In one example, the WTRU may request the status report based on the common delay budget for one or more current generation(s) expiring in a time bound e.g., configured by the NW. For example, in the case where the WTRU performs the retransmission/additional transmission functions in the RLC layer, the WTRU may transmit a RLC poll bit if the common delay budget for a generation is less than a time bound e.g., configured by the NW. For example, in the case where the WTRU performs the retransmission/additional transmission functions in the PDCP layer, the WTRU may transmit a request for a PDCP status report from its peer PDCP entity if the common delay budget for a generation is less than a time bound e.g., configured by the NW.

### Fifth Trigger: Send a Status Report Request Based on Buffer Status

In one example, the WTRU may request the status report after a change in data volume in the transmit buffer of the WTRU within a (e.g., certain) time window.

In a first example, the WTRU may request the status report after a configured number of generations may have been transmitted and/or generated within a (e.g., certain) time window.

In a second example, the WTRU may request the status report after a configured number of NC PDUs may have been transmitted and/or generated within a (e.g., certain) time window.

In third example, the WTRU may request the status report after a configured number of NC SDUs may have arrived in the buffer within a (e.g., certain) time window.

The reference point for the start of the time window may be defined as any of (i) a function of the time of reception of the last status report, (ii) a function of the time of the last transmission of an NC PDU e.g., to the lower layers, and (iii) a function of the time of the last transmission of NC PDUs for which an acknowledgement may not have been received yet.

### Requesting a Status Report With Specific Format

As described herein; a status report may be requested based on any of (e.g., specific) fields in a data PDU header and via an independent control signaling method such as a MAC CE. A WTRU may be configured to request a status report based on using any of fields in a data PDU header and an independent control signaling method such as a MAC CE.

In one example, the WTRU may select a status report format based on information provided by the NW in a previous status report. The WTRU may request a status report containing more specific information than what may have been included in a previously received status report. This additional information may allow the WTRU to perform more targeted retransmissions.

For example, in the case where the WTRU receives a negative acknowledgement of a generation, the WTRU may request a status report containing information indicating the number of NC PDUs (e.g., needed, to be used) to recover the generation.

For example, in the case where the WTRU receives a negative acknowledgement of a generation, the WTRU may request a status report containing a report indicating recommended coding coefficients for an NC PDU.

A previously received status report may act as a trigger for a status report request regardless of whether the previously received status report may have been previously requested by the WTRU or not.

In one example, the WTRU may select a status report format to request based on one or more of (i) the number of NC PDUs previously sent and generated from a (e.g., certain) generation, (ii) the characteristics of NC PDUs previously sent and generated from a (e.g., certain) generation, (iii) the generation size, (iv) the NC code rate and (v) other NC configuration parameters.

In one example, two or more RLC entities may be associated with the same PDCP entity and may transmit NC PDUs belonging to the same generation. The WTRU may be configured to request status reports from the different RLC according to a (e.g., certain) order.

For example, the WTRU may be configured to request a status report from a RLC entity to which NC PDUs with specific characteristics (e.g., systematic NC PDUs) may have been transmitted before requesting a status report from another entity(ies).

For example, the WTRU may be configured to request a status report from a (e.g., configured) primary RLC entity before requesting a status report from another entity(ies).

For example, the WTRU may be configured to request a status report from a RLC entity to which required NC PDUs for decoding may have been transmitted (at least X NC PDUs being transmitted) before requesting a status report from another entity(ies).

For example, the WTRU may be configured to request status report from other RLC entities carrying NC PDUs generated from the same generation as a function of a received status report from a (e.g., certain) RLC entity.

For example, the WTRU may be configured to request a status report from more than one RLC entity (e.g., simultaneously) e.g., requesting status report from two RLC entities where the first one may carry less-innovative NC PDUs and the second one may carry more-innovative NC PDUs.

### WTRU Procedure for Retransmission/Additional Transmissions and NC Configuration Update

A procedure, implemented in a WTRU for retransmission/additional transmissions and NC Configuration update is described herein.

In an example, the WTRU may receive a status report comprising information associated with at least one network coding generation.

In an example, in response to the status report, the WTRU may transmit at least one network coded packet generated using the at least one network coding generation based on the status report and the configuration information. In a first example, the at least one network coded packet may comprise at least one additional network coded packet to be transmitted for the at least one network coding generation (e.g., the at least one additional network coded packet may not have been transmitted yet for the at least one network coding generation). In a second example, the at least one network coded packet may comprise at least one already transmitted network coded packet that may not have been indicated by the status report as missing, e.g., the status report may indicate the number of missing network coded packets and may not indicate which network coded packets may be missing. The retransmission may be performed based on (e.g., only) an indication of a number of missing network coded packets.

### Retransmission and Additional Transmission Buffer Management

Retransmission and additional transmission buffer management are described herein.

### Storing NC PDUs in the Retransmission Buffer

Storing NC PDUs in the retransmission buffer is described herein.

### Retransmission Buffer Management

In one example, the WTRU may store NC PDUs in the retransmit buffer as a function of the NC configuration as described herein.

In a first example, the WTRU may maintain a NC PDU retransmit buffer that may store a copy of (e.g., all) NC PDUs that may be generated.

For example, in the case where the WTRU performs the retransmission/additional transmission functions in the RLC layer, the WTRU may store a RLC SDU (or RLC SDU segment if segmentation is used) with the same NC coefficients in the RLC retransmission buffer for (e.g., all) RLC SDUs that may be NC PDUs.

For example, in the case where the WTRU performs the retransmission/additional transmission functions in the PDCP layer, the WTRU may store a PDCP PDU with the same NC coefficients in the PDCP retransmission buffer for (e.g., all) PDCP PDUs that may be NC PDUs.

In a second example, the WTRU may maintain a NC PDU retransmit buffer that may store the NC coefficients and the PDU sequence number of (e.g., all) NC PDUs that may be generated. The WTRU may (e.g., also) store the NC SDUs of the generation to regenerate the NC PDUs.

For example, in the case where the WTRU performs the retransmission/additional transmission functions in the RLC layer and if no segmentation is used, the WTRU may store the NC coefficients and the SDU sequence number of the RLC SDUs that may be generated. The WTRU may (e.g., also) store the NC SDUs of the generation to regenerate the RLC SDUs.

For example, in the case where the WTRU performs the retransmission/additional transmission functions in the RLC layer and if segmentation is used, the WTRU may store the NC coefficients, the sequence number of the RLC SDUs that may be generated and the byte offsets of the segments. The WTRU may (e.g., also) store the NC generation to regenerate the RLC SDUs.

For example, in the case where the WTRU performs the retransmission/additional transmission functions in the PDCP layer, the WTRU may store the NC coefficients and sequence number of the PDCP PDUs that may be generated. The WTRU may (e.g., also) store the NC SDUs of the generation to regenerate the PDCP PDUs.

In a third example, the WTRU may maintain a NC PDU retransmission/additional transmission buffer of new NC PDUs that may be to be sent as additional transmissions and may not store copies of previously transmitted NC PDUs.

For example, in the case where the WTRU performs the retransmission/additional transmission functions in the RLC layer, the WTRU may store a RLC SDU (or RLC SDU segment if segmentation is used) with different NC coefficients in the RLC retransmission buffer for (e.g., all) RLC SDUs that may be NC PDUs.

For example, in the case where the WTRU performs the retransmission/additional transmission functions in the PDCP layer, the WTRU may store a PDCP PDU with different NC coefficients in the PDCP retransmission buffer for (e.g., all) PDCP PDUs that may be NC PDUs.

In a fourth example, the WTRU may maintain a NC PDU retransmission/additional transmission buffer that may include (e.g., both all) NC PDUs that may have been transmitted and additional NC PDUs that may be transmitted if more NC PDUs from that generation are (e.g., needed) to be received at the NW.

For example, in the case where the WTRU performs the retransmission/additional transmission functions in the RLC layer, the WTRU may store a RLC SDU (or RLC SDU segment if segmentation is used) with the same or different NC coefficients in the RLC retransmission buffer for (e.g., all) RLC SDUs that may be NC PDUs.

For example, in the case where the WTRU performs the retransmission/additional transmission functions in the PDCP layer, the WTRU may store a PDCP PDU with the same or different NC coefficients in the PDCP retransmission buffer for (e.g., all) PDCP PDUs that may be NC PDUs.

In a fifth example, the WTRU may maintain a NC PDU retransmission/additional transmission buffer that may include NC PDUs that may be sent based on NC characteristics (any of innovativeness, importance, systematic NC PDUs, NC PDUs with importance level above a configured threshold, delay budget, etc.).

For example, in the case where the WTRU performs the retransmission/additional transmission functions in the RLC layer, the WTRU may store a RLC SDU (or RLC SDU segment if segmentation is used) in the retransmission buffer based on NC PDU characteristics (any of innovativeness, importance, systematic NC PDUs, NC PDUs with importance level above a configured threshold, delay budget, etc.).

For example, in the case where the WTRU performs the retransmission/additional transmission functions in the PDCP layer, the WTRU may store a PDCP PDU in the retransmission buffer based on NC PDU characteristics (any of innovativeness, importance level, systematic NC PDUs, NC PDUs with importance level above a configured threshold, delay budget, etc.).

In a sixth example, the WTRU may store NC PDUs carrying information that may not be carried by other generated NC PDUs.

In a seventh example, the WTRU may store NC PDUs carrying information that may be partially carried by other generated NC PDUs.

In one other example, two or more RLC entities may be associated with the same PDCP entity and may transmit NC PDUs belonging to the same generation. The WTRU may selectively store one or more NC PDUs in the retransmission/additional transmission buffer of an RLC based on the transmitted NC PDUs from another RLC entity.

For example, the WTRU may store NC PDUs in the retransmission/additional transmission buffer of an RLC entity carrying information that may not be carried by the other transmitted NC PDUs from the same RLC entity or other RLC entities.

For example, the WTRU may store NC PDUs in the retransmission/additional transmission buffer of an RLC entity carrying information that may be partially carried by other transmitted NC PDUs from the same RLC entity or other RLC entities.

For example, the WTRU may store one or more NC PDUs in the retransmission/additional transmission buffer of an RLC entity if they are more innovative than NC PDUs belonging to the other RLC entities.

In one other example, two or more RLC entities may be associated with the same PDCP entity and may transmit NC PDUs belonging to the same generation. The WTRU may selectively store one or more NC PDUs in the retransmission/additional transmission buffer at an RLC entity based on a received status report for another RLC entity.

For example, at an RLC entity, the WTRU may store, in the retransmission/additional transmission buffer for an RLC entity, NC PDUs carrying information about one or more NC PDUs unacknowledged by another RLC entity.

For example, at an RLC entity, the WTRU may store, in the retransmission/additional transmission buffer for an RLC entity, (e.g., all) NC PDUs if the number of existing NC PDUs is less than the number of NC PDUs unacknowledged by another RLC entity.

For example, at an RLC entity, the WTRU may store, in the retransmission/additional transmission buffer for an RLC entity, a number of NC PDUs based on the number of NC PDUs acknowledged by another RLC entity. For instance, the WTRU may store a number R of NC PDUs such that the summation of the number R and the number of acknowledged NC PDUs is greater than or equal to X.

For example, at an RLC entity, the WTRU may store, in the retransmission/additional transmission buffer for an RLC entity, a number of NC PDUs based on the number of NC PDUs unacknowledged by another RLC entity. For instance, the WTRU may store a number R of NC PDUs such that the number R is greater than or equal to number of unacknowledged NC PDUs, etc.

### Removing NC PDUs From the Retransmission Buffer

In one example, the WTRU may remove NC PDUs from the retransmit buffer as a function of the NC configuration, as described herein.

In an example, the WTRU may receive an indication that at least one network coding generation may have been recovered. The WTRU may remove from the transmit buffer the network coded packets associated with the at least one network coding generation.

In a first example, the WTRU may remove from the retransmit buffer (e.g., all) the NC PDUs from a generation when the NW feedback may indicate the generation may have been decoded.

For example, in the case where the WTRU performs the retransmission/additional transmission functions in the RLC layer, the WTRU may remove (e.g., all) RLC SDUs generated from a generation that may have been recovered per the RLC STATUS PDU and may remove RLC SDU segments (if RLC segmentation is used) if the RLC SDUs that may be segmented are generated from a generation that may have been recovered per (e.g., based on) the RLC STATUS PDU.

For example, in the case where the WTRU performs the retransmission/additional transmission functions in the PDCP layer, the WTRU may remove (e.g., all) PDCP PDUs generated from a generation that may have been recovered per (e.g., based on) the PDCP status report.

In a second example, the WTRU may remove from the retransmit buffer NC PDUs after they may have been determined not to be innovative as per the information provided in the status report received from the NW e.g., based on the acknowledged NC PDUs.

For example, in the case where the WTRU performs the retransmission/additional transmission functions in the RLC layer, the WTRU may remove (e.g., all) RLC SDUs that may not be innovative as determined per the acknowledged RLC SDUs in the RLC STATUS PDU and may remove (e.g., all) RLC SDU segments that may be segments of RLC SDUs that may not be innovative as determined per the acknowledged RLC SDUs in the RLC STATUS PDU.

For example, in the case where the WTRU performs the retransmission/additional transmission functions in the PDCP layer, the WTRU may remove (e.g., all) PDCP PDUs that may not be innovative as determined per the acknowledged PDCP PDUs in the PDCP status report.

In a third example, the WTRU may remove NC PDUs from the retransmit buffer based on one or more characteristics (any of innovation, importance, etc.). The WTRU may remove the PDUs based on a (e.g., NW configured) threshold and information provided in the status report received from the NW.

For example, in the case where the WTRU performs the retransmission/additional transmission functions in the RLC layer and if RLC segmentation is not used, the WTRU may remove RLC SDUs based on the one or more NC characteristics (any of innovativeness, importance, etc.) and the acknowledged RLC SDUs per the RLC STATUS PDU. The WTRU may remove the RLC SDUs based on a (e.g., NW configured) threshold and information provided in the status report received from the NW.

For example, in the case where the WTRU performs the retransmission/additional transmission functions in the RLC layer and if RLC segmentation is used, the WTRU may remove RLC SDU segments that may be segments of RLC SDUs based on the one or more NC characteristics (any of innovativeness, importance, etc.) and the acknowledged RLC SDU segments per the RLC STATUS PDU. The WTRU may remove the RLC SDUs based on a (e.g., NW configured) threshold and information provided in the status report received from the NW.

For example, in the case where the WTRU performs the retransmission/additional transmission functions in the PDCP layer, the WTRU may remove PDCP PDUs based on the one or more NC characteristics (any of innovativeness, importance, etc.) and the acknowledged PDCP PDUs per the PDCP status report. The WTRU may remove the PDCP PDUs based on a (e.g., NW configured) threshold and information provided in the status report received from the NW.

In a fourth example, the WTRU may remove NC PDUs from the retransmit buffer based on one or more characteristics (any of innovation, importance, etc.). The WTRU may remove NC PDUs to maintain a (e.g., certain) number of NC PDUs in the retransmission buffer and may prioritize packets to keep in the retransmission buffer based on one or more NC characteristics (any of innovativeness, importance, etc.).

For example, in the case where the WTRU performs the retransmission/additional transmission functions in the RLC layer and if RLC segmentation is not used, the WTRU may remove RLC SDUs based on the one or more NC characteristics (any of innovativeness, importance, etc.) and the acknowledged RLC SDUs per the RLC STATUS PDU. The WTRU may remove the RLC SDUs to maintain a (e.g., certain) number of RLC SDUs in the retransmission buffer and may prioritize packets to keep in the retransmission buffer based on the one or more NC characteristics (any of innovativeness, importance, etc.).

For example, in the case where the WTRU performs the retransmission/additional transmission functions in the RLC layer and if RLC segmentation is used, the WTRU may remove RLC SDU segments that may be segments of RLC SDUs based on the one or more NC characteristics (any of innovativeness, importance, etc.) and the acknowledged RLC SDU segments per the RLC STATUS PDU. The WTRU may remove the RLC SDUs to maintain a (e.g., certain) number of RLC SDUs in the retransmission buffer and may prioritize packets to keep in the retransmission buffer based on the one or more NC characteristics (any of innovativeness, importance, etc.).

For example, in the case where the WTRU performs the retransmission/additional transmission functions in the PDCP layer, the WTRU may remove PDCP PDUs based on the one or more NC characteristics (any of innovativeness, importance, etc.) and the acknowledged PDCP PDUs per the PDCP status report. The WTRU may remove the PDCP PDUs to maintain a (e.g., certain) number of PDCP PDUs in the retransmission buffer and may prioritize packets to keep in the retransmission buffer based on the one or more NC characteristics (any of innovativeness, importance, etc.)

For example, the WTRU may remove NC PDUs carrying information that may be carried by other generated NC PDUs.

In an example, the WTRU may remove NC PDUs from the transmit buffer after they may have been transmitted during a retransmission. The WTRU may remove the NC PDUs transmitted from the transmit buffer in order to allow (e.g., guarantee) that any transmitted NC PDUs during a retransmission may be innovative NC PDUs, e.g., linearly independent of (e.g., all) previously transmitted NC PDUs.

In one other example, two or more RLC entities may be associated with the same PDCP entity and may transmit NC PDUs belonging to the same generation. The WTRU may remove one or more NC PDUs from the retransmission/additional transmission buffer of an RLC entity based on the NC PDUs transmitted by another RLC entity.

For example, the WTRU may remove one or more NC PDUs from the retransmission/additional transmission buffer of an RLC entity if those NC-PDUs carry information that may be (e.g., fully) carried by other transmitted NC PDUs from the same RLC entity or other RLC entities.

For example, the WTRU may remove one or more NC PDUs from the retransmission/additional transmission buffer of an RLC entity if those NC-PDUs are less innovative than NC PDUs belonging to another RLC entity.

In one other example, two or more RLC entities may be associated with the same PDCP entity and may transmit NC PDUs belonging to the same generation. The WTRU may remove from the retransmission/additional transmission buffer of an RLC entity one or more NC PDUs at an RLC entity based on received status report for another RLC entity.

For example, at an RLC entity, the WTRU may remove from the retransmission/additional transmission buffer of an RLC entity any NC PDUs carrying information carried by one or more of NC PDUs that may have been previously acknowledged at another RLC entity.

For example, at an RLC entity, the WTRU may remove from the retransmission/additional transmission buffer of an RLC entity any a number of NC PDUs based on the number of NC PDUs acknowledged at another RLC entity. For instance, the WTRU may remove a number L of NC PDUs such that the summation of remaining NC PDUs at the RLC entity and the number of acknowledged NC PDUs is greater than or equal to X.

### Retransmission/Additional Transmission Triggers

NC PDU retransmissions/additional transmissions may or may not be triggered by the reception of a status report from the NW.

In one example, the WTRU may not perform any retransmissions/additional transmissions unless it may be prompted to do so by a status report indicating that at least one NC generation may has not have been successfully recovered.

In another example, the WTRU may proactively transmit more NC PDUs if there are transmission resources available by generating new NC PDUs and/or choosing NC PDUs to be sent from the retransmission/additional transmission buffer regardless of the data/indication included in any status report(s). In an example, the WTRU may choose (e.g., determine) which NC PDU to retransmit or transmit based on characteristics (e.g. level of innovativeness). In an example, the WTRU may choose a NC PDU randomly.

In another example, the WTRU may perform retransmission/additional transmissions based on a status report from the NW. The WTRU may not perform retransmission/additional transmissions unless it may be in response to the reception of a status report from the NW.

For example, in the case where the WTRU performs the retransmission/additional transmission functions in the RLC layer, the WTRU may perform retransmission/additional transmissions based on the RLC STATUS PDU from the NW.

For example, in the case where the WTRU performs the retransmission/additional transmission functions in the PDCP layer, the WTRU may perform retransmission/additional transmissions based on the PDCP status report received from the NW.

In another example, (e.g., alternatively, or in addition to the reception of a status report), the WTRU may autonomously perform retransmission/additional transmission of NC PDUs based on one or more conditions, as described in the following examples.

In a first example of condition, the WTRU may perform retransmission/additional transmission of NC PDUs periodically, after a (e.g., certain) time period.

For example, in the case where the WTRU performs the retransmission/additional transmission functions in the RLC layer, the WTRU may perform retransmission/additional transmissions of RLC SDUs (or RLC SDU segments if RLC segmentation is used) after a (e.g., certain) time period (periodically after a (e.g., certain) time).

For example, in the case where the WTRU performs the retransmission/additional transmission functions in the PDCP layer, the WTRU may perform retransmission/additional transmissions of PDCP PDUs after a (e.g., certain) time period (periodically after a (e.g., certain) time).

In a second example of condition, the WTRU may perform retransmission/additional transmission of NC PDUs based on radio measurement conditions (e.g., any of a reference signal receive power (RSRP), a reference signal receive quality (RSRQ), a signal to interference noise ratio (SINR), a channel busy ratio (CBR), a channel quality indicator (CQI)) indicating channel condition being below a (e.g., configured) threshold (e.g., poor channel condition).

For example, in the case where the WTRU performs the retransmission/additional transmission functions in the RLC layer, the WTRU may perform retransmission/additional transmissions of RLC SDUs (or RLC SDU segments if RLC segmentation is used) if radio measurement(s) indicates one or more channel conditions (e.g., any of RSRP, RSRQ, SINR, CBR, CQI) below a (e.g., configured) threshold (e.g., poor channel condition).

For example, in the case where the WTRU performs the retransmission/additional transmission functions in the PDCP layer, the WTRU may perform retransmission/additional transmissions of PDCP PDUs after a (e.g., certain) number of PDCP PDUs if radio measurement(s) indicates one or more channel conditions (e.g., any of RSRP, RSRQ, SINR, CBR, CQI) below a (e.g., configured) threshold (e.g., poor channel condition).

In a third example of condition, the WTRU may perform retransmission/additional transmission of NC PDUs as a function of the delay budget of the NC PDUs.

For example, in the case where the WTRU performs the retransmission/additional transmission functions in the RLC layer, the WTRU may perform retransmission/additional transmissions of RLC SDUs (or RLC SDU segments if RLC segmentation is used) as a function of the delay budget of the RLC SDUs (or the delay budget of the RLC SDU(s) being segmented if RLC segmentation is used).

For example, in the case where the WTRU performs the retransmission/additional transmission functions in the PDCP layer, the WTRU may perform retransmission/additional transmissions of PDCP PDUs as a function of the delay budget of the PDCP PDUs.

### Selection of NC PDUs for Retransmission and/or Additional Transmission

After a NC PDU retransmission/additional transmission may have been triggered, the WTRU may select the number of NC PDUs to send and which NC PDUs to send.

For example, the received status report may indicate a number of any of missing network coded packets for recovering at least one network coding generation.

### Determination of the Number of NC PDUs for Retransmission and/or Additional Transmission

Determination of the number of NC PDUs for retransmission and/or additional transmission is described herein.

In one example, the WTRU may perform retransmission and/or additional transmission of a total number M of NC PDUs where M may be a value configured by the NW.

For example, in the case where the WTRU performs the retransmission/additional transmission functions in the RLC layer, the WTRU may perform retransmission and/or additional transmission of a total number M of RLC SDUs (or all segments of M RLC SDUs if RLC segmentation is enabled) from the RLC retransmission buffer where M may be a value configured by the NW.

For example, in the case where the WTRU performs the retransmission/additional transmission functions in the PDCP layer, the WTRU may perform retransmission and/or additional transmission of a total number M of PDCP PDUs from the PDCP retransmission buffer where M may be a value configured by the NW.

In one example, the WTRU may perform retransmission and/or additional transmission of a total number M of NC PDUs where M may be the number of NC PDUs reported as (e.g., required) to be received for a successful recovery of the SDUs that may form a NC generation.

For example, in the case where the WTRU performs the retransmission/additional transmission functions in the RLC layer, the WTRU may perform retransmission and/or additional transmission of a total number M of RLC SDUs (or all segments of M RLC SDUs if RLC segmentation is enabled) from the RLC retransmission buffer where M may be the number of RLC SDUs (included reassembled SDUs if RLC segmentation is used) reported as (e.g., required) to be received for a successful recovery of the NC SDUs that may form a NC generation.

For example, in the case where the WTRU performs the retransmission/additional transmission functions in the PDCP layer, the WTRU may perform retransmission and/or additional transmission of a total number M of PDCP PDUs from the PDCP retransmission buffer where M may be the number of PDCP PDUs reported as (e.g., required) to be received for a successful recovery of the NC SDUs that may form a NC generation.

In one example, the WTRU may perform retransmission and/or additional transmission of a total number M of NC PDUs where M may be the number of NC PDUs reported as (e.g., required) to be received for a successful recovery of the SDUs that may form a NC generation plus additional NC PDUs based on the NC code rate (CR) configured by the NW.

For example, in the case where the WTRU performs the retransmission/additional transmission functions in the RLC layer, the WTRU may perform retransmission and/or additional transmission of a total number M of RLC SDUs (or all segments of M RLC SDUs if RLC segmentation is enabled) from the RLC retransmission buffer where M may be the number of RLC SDUs (included reassembled SDUs if RLC segmentation is used) reported as (e.g., required) to be received for a successful recovery of the NC SDUs that may form a NC generation plus additional NC PDUs based on the NC CR configured by the NW.

For example, in the case where the WTRU performs the retransmission/additional transmission functions in the PDCP layer, the WTRU may perform retransmission and/or additional transmission of a total number M of PDCP PDUs from the PDCP retransmission buffer where M may be the number of PDCP PDUs reported as (e.g., required) to be received for a successful recovery of the NC SDUs that may form a NC generation plus additional NC PDUs based on the NC CR configured by the NW.

In one example, the WTRU may perform retransmission and/or additional transmission of a total number M of NC PDUs where M may be the number of NC PDUs reported as (e.g., required) to be received for a successful recovery of the SDUs that may form a NC generation plus additional NC PDUs based on the updated NC CR included in the status report.

For example, in the case where the WTRU performs the retransmission/additional transmission functions in the RLC layer, the WTRU may perform retransmission and/or additional transmission of a total number M of RLC SDUs (or all segments of M RLC SDUs if RLC segmentation is enabled) from the RLC retransmission buffer where M may be the number of RLC SDUs (included reassembled SDUs if RLC segmentation is used) reported as (e.g., required) to be received for a successful recovery of the NC SDUs that may form a NC generation plus additional NC PDUs based on the updated NC CR included in the status report.

For example, in the case where the WTRU performs the retransmission/additional transmission functions in the PDCP layer, the WTRU may perform retransmission and/or additional transmission of a total number M of PDCP PDUs from the PDCP retransmission buffer where M may be the number of PDCP PDUs reported as (e.g., required) to be received for a successful recovery of the NC SDUs that may form a NC generation plus additional NC PDUs based on the updated NC CR included in the status report.

In one example, the WTRU may perform retransmission and/or additional transmission of a total number M of NC PDUs where M may be a function of the required number of NC PDUs and/or the NC CR as per the NC configuration. This example may be used in situations where no feedback may have been received and retransmission/additional transmission may (e.g., still) be performed.

In one example, the WTRU may perform retransmission/additional transmission of a total number M of NC PDUs where M may be a function of the radio measurement(s) indicating the channel conditions.

### Selection of NC PDUs to be Retransmitted and/or Additionally Transmitted

Selection of NC PDUs to be retransmitted and/or additionally transmitted is described herein.

In one example, the WTRU may transmit additional NC PDUs using the coding coefficients specified (e.g., indicated) by the status report any of explicitly or via the specified (e.g., indicated) row in the generator matrix.

For example, in the case where the WTRU performs the retransmission/additional transmission functions in the RLC layer, the WTRU may transmit additional RLC SDUs (including segments of SDUs in the case of segmentation) using the coding coefficients specified (e.g., indicated) by the RLC STATUS PDU any of explicitly or via the specified (e.g., indicated) row in the generator matrix.

For example, in the case where the WTRU performs the retransmission/additional transmission functions in the PDCP layer, the WTRU may transmit additional PDCP PDUs using the coding coefficients specified (e.g., indicated) by the PDCP status report any of explicitly or via the specified (e.g., indicated) row in the generator matrix.

In one example, the WTRU may transmit additional NC PDUs based on the missing NC SDUs specified (e.g., indicated) by the status report by choosing (e.g., determining) NC PDUs that can be used to decode these NC SDUs from the retransmit buffer.

For example, in the case where the WTRU performs the retransmission/additional transmission functions in the RLC layer, the WTRU may transmit additional RLC SDUs (including segments of SDUs in the case of segmentation) based on the missing RLC SDUs (or SDU segments in the case of segmentation) specified (e.g., indicated) by the RLC STATUS PDU report. The WTRU may retransmit RLC SDUs (or SDU segments in the case of segmentation) and/or transmit additional RLC SDUs (or SDU segments in the case of segmentation).

For example, in the case where the WTRU performs the retransmission/additional transmission functions in the PDCP layer, the WTRU may transmit additional PDCP PDUs based on the missing PDCP PDUs specified (e.g., indicated) by the PDCP status report. The WTRU may retransmit PDCP PDUs and/or transmit additional PDCP PDUs.

In one example, the WTRU may transmit additional NC PDUs generated from the same generation by (e.g., randomly) choosing (e.g., selecting) these NC PDUs from the retransmit buffer that may have been transmitted before and may have been negatively acknowledged (retransmission) or may not have been transmitted before (additional transmission).

For example, in the case where the WTRU performs the retransmission/additional transmission functions in the RLC layer, the WTRU may transmit additional RLC SDUs (including segments of SDUs in the case of segmentation) by (e.g., randomly) choosing RLC SDUs from the retransmit buffer that may have been transmitted before (retransmission) or may not have been transmitted before (additional transmission). In an example, another round of RLC segmentation may be used when performing retransmission/additional transmission of the RLC SDUs.

For example, in the case where the WTRU performs the retransmission/additional transmission functions in the PDCP layer, the WTRU may transmit additional PDCP PDUs by (e.g., randomly) choosing the PDCP PDUs from the retransmit buffer that may have been transmitted before (retransmission) or may not have been transmitted before (additional transmission).

In one example, the WTRU may choose (e.g., determine) which NC PDUs as a function of the format of the received status report. For example, if the status report includes the PDU sequence number of the (e.g., required) NC SDUs (e.g., to be used) to recover the generation, the WTRU may transmit additional NC PDUs that may be linear combinations of the (e.g., required) NC SDUs (e.g., to be used to recover the generation), using non-zero coding coefficients. In another example, if the status report includes (e.g., only) the number of (e.g., required) NC SDUs (e.g., to be used) to recover the generation, the WTRU may transmit additional NC PDUs that may linear combinations of (e.g., all, any) source NC SDUs, using non-zero coding coefficients.

In one example, two or more RLC entities may be associated with the same PDCP entity and may transmit NC PDUs belonging to the same generation. The WTRU may select the RLC entity(ies) from which it may perform retransmission/additional transmission based on the received status report(s) from (e.g., all) RLC entities.

For example, the WTRU may select the RLC entity(ies) carrying more innovative NC PDUs for retransmission/additional transmission if the number of unacknowledged NC PDUs at another RLC entity(ies) is above a threshold.

For example, the WTRU may select the RLC entity(ies) carrying less innovative NC PDUs for retransmission/additional transmission if the number of unacknowledged NC PDUs at another RLC entity(ies) is below a threshold.

For example, the WTRU may select the RLC entity(ies) for retransmission/additional transmission if the NC PDUs carried by these RLC entity(ies) carry information that may be carried by NC PDUs that may be unacknowledged at another RLC entity(ies).

In one example, two or more RLC entities may be associated with the same PDCP entity and may transmit NC PDUs belonging to the same generation. The WTRU may select the RLC entity(ies) from which it may perform retransmission/additional transmission based on the configurations of its associated logical channel(s) (LCH(s)).

For example, the WTRU may select the RLC entity(ies) for retransmission/additional transmission that may be associated with the LCH(s) satisfying a first condition (e.g., with highest priority).

For example, the WTRU may select the RLC entity(ies) for retransmission/additional transmission that may be associated with the LCH(s) satisfying a second condition (e.g., having LCH priority above a threshold).

For example, the WTRU may select the RLC entity(ies) for retransmission/additional transmission that may be associated with the LCH(s) satisfying a third condition (e.g., configured with higher subcarrier spacing).

For example, the WTRU may select the RLC entity(ies) for retransmission/additional transmission that may be associated with the LCH(s) satisfying a fourth condition (e.g., configured with a serving cell with lowest number of HARQ retransmissions).

For example, the WTRU may select a primary RLC entity for retransmission/additional transmission.

For example, the WTRU may select secondary RLC entity(ies) for retransmission/additional transmission.

### Updating NC Configuration Based on Feedback

Updating NC configuration based on feedback is described herein.

In one example, the WTRU may operate changes to the NC configuration based on the feedback from the status report received from the BS as described herein.

In one example, the WTRU may update the NC CR based on the new NC CR recommended (e.g., indicated) by the receiver in the status report. For example, the status report may indicate a new code rate. The WTRU may to update the code rate to the new code rate and may apply the new code rate to any of the current network coding generation and a subsequent network coding generation.

For example, in the case where the WTRU performs the retransmission/additional transmission functions in the RLC layer, the WTRU may update the NC CR based on the NC CR recommended (e.g., indicated) by the RLC STATUS PDU.

For example, in the case where the WTRU performs the retransmission/additional transmission functions in the PDCP layer, the WTRU may update the NC CR based on the NC CR recommended (e.g., indicated) by the PDCP status report.

In one example, the WTRU may update the NC CR based on the ratio of the number of NC PDUs received per generation (e.g., including extra packets). If extra NC PDUs are received, as per the status report (e.g., compared to X), the WTRU may increase the NC CR. If insufficient NC PDUs are received, as per the status report, to recover the generation the WTRU may decrease the NC CR.

For example, in the case where the WTRU performs the retransmission/additional transmission functions in the RLC layer, the WTRU may update the NC CR based on the number of RLC SDUs (including segments of SDUs in the case of segmentation) received per generation as specified (e.g., indicated) by the RLC STATUS PDU. If extra RLC SDUs (or segments of RLC SDUs in the case of segmentation) are received as per the status report, the WTRU may increase the NC CR. If insufficient RLC SDUs (or segments of RLC SDUs in the case of segmentation) are received as per the status report, the WTRU may decrease the NC CR.

For example, in the case where the WTRU performs the retransmission/additional transmission functions in the PDCP layer, the WTRU may update the NC CR based on the number of packets received per generation as specified (e.g., indicated) by the PDCP status report. If extra PDCP PDUs are received as per the status report, the WTRU may increase the NC CR. If insufficient PDCP PDUs are received as per the status report to recover the generation the WTRU may decrease the NC CR.

In one example, the WTRU may update the NC CR based on the number of packets sent by the WTRU and the generations that may be acknowledged in the status report. If extra NC PDUs are sent and (e.g., all) NC generations have been recovered, as per the status report, the WTRU may increase the NC CR. If extra NC PDUs are sent and not all NC generations have been recovered, as per the status report, the WTRU may decrease the status report.

For example, in the case where the WTRU performs the retransmission/additional transmission functions in the RLC layer, the WTRU may update the NC CR based on the generations acknowledged by the RLC STATUS PDU. If extra RLC SDUs (or segments of RLC SDUs in the case of segmentation) are sent and (e.g., all) generations have been recovered, as per the status report, the WTRU may increase the NC CR. If extra RLC SDUs (or segments of RLC SDUs in the case of segmentation) are sent and not all generations have been recovered, as per the status report, the WTRU may decrease the NC CR.

For example, in the case where the WTRU performs the retransmission/additional transmission functions in the PDCP layer, the WTRU may update the NC CR based on the generations acknowledged by the PDCP status report. If extra PDCP PDUs are sent and (e.g., all) NC generations have been recovered, as per the status report, the WTRU may increase the NC CR. If extra PDCP PDUs are sent and not all NC generations have been recovered, as per the status report, the WTRU may decrease the status report.

### WTRU Procedure for Updating Receiving Window

A WTRU procedure for updating the receiving window is described herein.

In the legacy system, the lower edge of the transmitting window (e.g., RLC transmitting window) may be incremented when an RLC SDU is received from the upper layers. With NC, one or more NC PDU may not be received from the higher layers as some may be redundant packets that may not (e.g., have to) be retransmitted.

In an example, a WTRU may receive an indication that at least one network coding generation may have been recovered. The WTRU may update a lower edge of a transmitting window to be a first network coded packet generated using a next network coding generation to be recovered.

### WTRU Updating the Lower Edge of the Transmitting Window Based on the Acknowledgement of the Generation

In one example, the WTRU may update the lower edge of the transmitting window by incrementing the window after at least X NC PDUs generated using the same generation may have been acknowledged for the lowest generation within the transmit window. The WTRU may update the lower edge based on the NC code rate. Considering Y output packets per generation, the WTRU may increment the lower edge of the receiver by Y after (e.g., each time) a generation may be successfully decoded. This may allow the WTRU to discard NC PDUs from the higher layers generated from generations that may have already been decoded.

### WTRU Updating the Lower Edge of a Transmitting Window Tracking Generations

In one example, the WTRU may have a transmitting window that may track NC generations e.g., in lieu of (or in addition to) PDUs. The BS may have a configured window size that may be the number of generations. NC PDUs that may be generated from a generation that may be within the generation transmitting window may not be discarded. NC PDUs that may not be generated from a generation that may be within the generation transmitting window may be discarded.

For example, the WTRU may update the lower edge of the transmitting window to the lowest generation identifier that may be (e.g., still) being transmitted based on the data indicated in the status report.

For example, the WTRU may update the lower edge of the transmitting window to the lowest generation identifier that may be (e.g., still) being transmitted based on the delay budget of the NC generations that may be being transmitted. The lower edge of the WTRU may be moved to remove generations from the transmitting window that may have expired based on the delay budget.

### First Example of NC-Based Retransmission Method

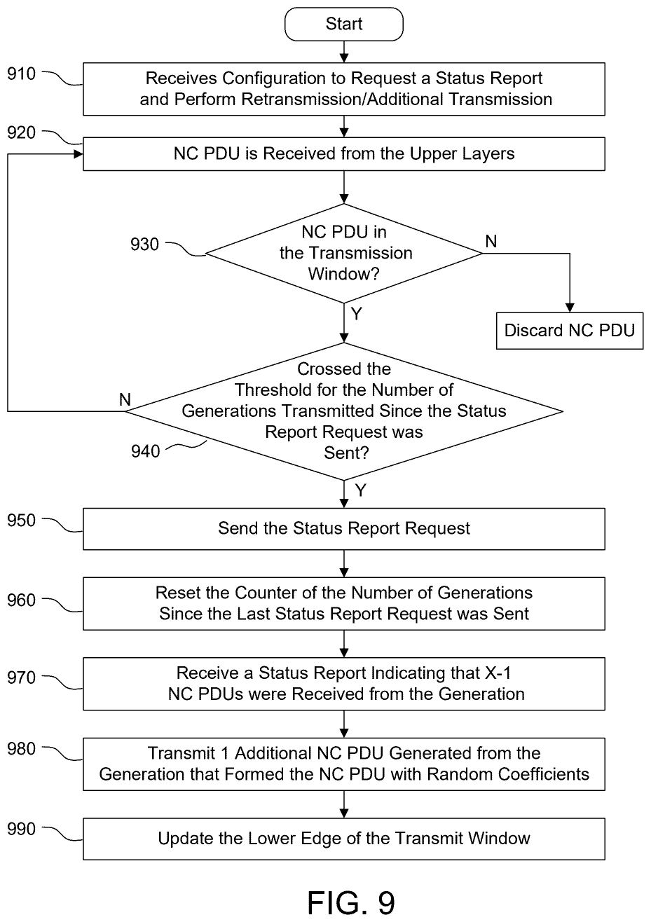

FIG. 9 is a diagram illustrating a first example method for requesting feedback from the NW and retransmitting/sending additional NC PDUs based on the feedback.

As shown at 910, the WTRU may be configured with one or more of: (i) a NC code rate, (ii) a lower bound (e.g., minimum) number of NC PDUs (e.g., required) to decode the NC SDUs of the NC generation (referred to herein as X), (iii) a total number of permitted retransmissions/additional transmissions of NC PDUs per generation, and (iv) a parameter indicating the number of generations between triggers of polls.

As shown at 920, the WTRU may receive a NC PDU from the upper layer.

As shown at 930, the WTRU may determine that the NC PDU may be in the transmission window.

As shown at 940, the WTRU may determine that the configured threshold may have been crossed for the number of generations transmitted since the last poll bit was sent.

As shown at 950, the WTRU may send an NC PDU with the status report request (e.g., to lower layers).

As shown at 960, the WTRU may reset the counter.

As shown at 970, the WTRU may receive a status report indicating that X-1 NC PDUs may have been received from the generation.

As shown at 980, the WTRU may transmit one additional NC PDU generated from the generation that may have generated the NC PDU with e.g., random coefficients.

As shown at 990, the WTRU may update the lower edge of the transmit window e.g., to indicate that the newly generated NC PDUs may have been sent.

### Second Example of NC-Based Retransmission Method

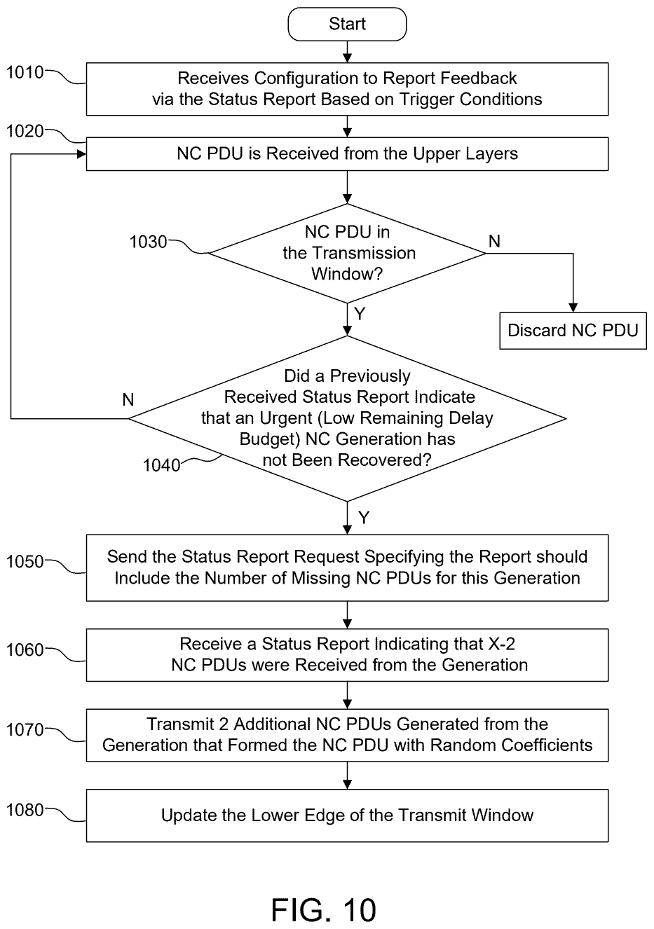

FIG. 10 is a diagram illustrating a second example method for requesting feedback from the NW and retransmitting/sending additional NC PDUs based on the feedback.

As shown at 1010, the WTRU may be configured with one or more of: (i) a NC code rate, (ii) a lower bound (e.g., minimum) number of NC PDUs (e.g., required) to decode the NC SDUs of the NC generation (referred to herein as X), (iii) a total number of permitted retransmissions/additional transmissions of NC PDUs per generation, and (iv) a parameter indicating the number of generations between triggers of polls.

As shown at 1020, the WTRU may receive a NC PDU from the upper layer.

As shown at 1030, the WTRU may determine that the NC PDU may be in the transmission window.

As shown at 1040, the WTRU may determine that based on a previously received status report indicating that a NC generation may require more NC PDUs to be recovered and the remaining delay budget of that NC generation, the WTRU may request a status report with additional information.

As shown at 1050, the WTRU may send an NC PDU with the status report request (e.g., to lower layers) specifying (e.g., indicating) the report may be to include the number of missing NC PDUs for a (e.g., certain) generation.

As shown at 1060, the WTRU may receive a status report indicating that X-2 NC PDUs may have been received from the generation.

As shown at 1070, the WTRU may transmit two additional NC PDUs generated from the generation that may have generated the NC PDU with e.g., random coefficients.

As shown at 1080, the WTRU may update the lower edge of the transmit window e.g., to indicate that the newly generated NC PDUs may have been sent.

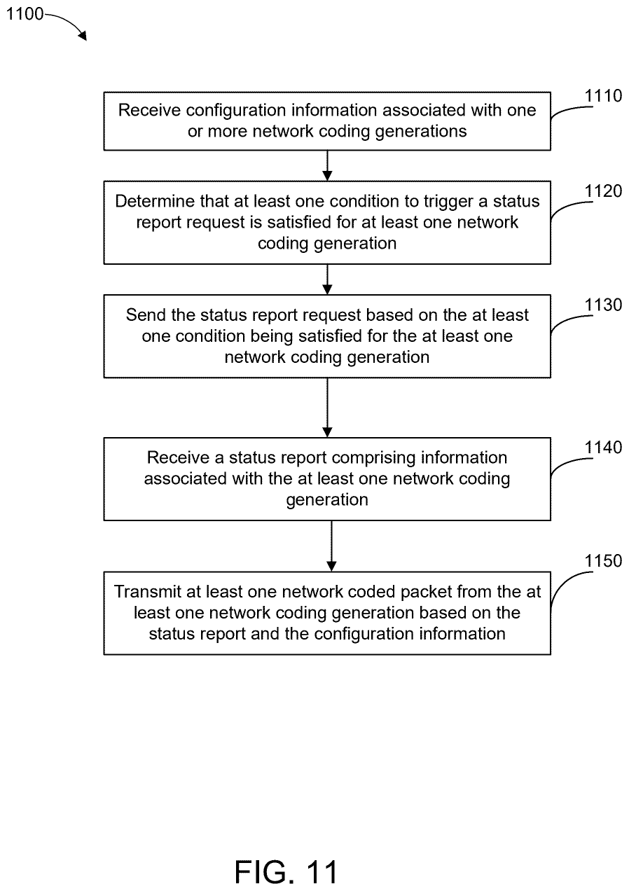

FIG. 11 is a diagram illustrating an example method 1100 for feedback management in presence of network coding, implemented in a WTRU. The WTRU may include circuitry including any of transmitter, a receiver, a processor, and a memory. The circuitry may be configured to carry out the method 1100. As shown at 1110, the method 1100 may include receiving configuration information associated with one or more network coding generations. As shown at 1120, the method 1100 may include determining that at least one condition to trigger a status report request may be satisfied for at least one network coding generation. As shown at 1130, the method 1100 may include sending the status report request based on the at least one condition being satisfied for the at least one network coding generation. As shown at 1140, the method 1100 may include receiving a status report including information associated with the at least one network coding generation. As shown at 1150, the method 1100 may include transmitting at least one network coded packet generated using the at least one network coding generation based on the status report and the configuration information. In various embodiments, the at least one network coded packet may include at least one additional network coded packet to be transmitted for the at least one network coding generation. For example, the at least one additional network coded packet may not have been transmitted yet for the at least one network coding generation

In various embodiments, a network coding generation may comprise a set of source packets being coded together.

In various embodiments, the configuration information may indicate any of (i) a network coding code rate, (ii) a number of network coded packets to be used to recover a network coding generation, (iii) a maximum number of transmissions of network coded packets per network coding generation, and (iv) a number of network coding generations between triggers of status report requests.

In various embodiments, the maximum number of transmissions of network coded packets may comprise any of a maximum number of retransmissions of network coded packets and a maximum number of transmissions of additional network coded packets.

In various embodiments, the at least one condition to trigger the status report request may be satisfied in a case where a number of network coding generations transmitted since a previous status report has been requested, is above a threshold.

In various embodiments, the at least one condition to trigger the status report request may be satisfied in a case where all network coded packets generated using the one or more network coding generations have been transmitted.

In various embodiments, the at least one condition to trigger the status report request may be satisfied in a case where a delay budget for the at least one network coding generation is less than a time bound.

In various embodiments, the status report request may indicate the at least one network coding generation for which information may be to be included in the status report.

In various embodiments, the status report request may indicate if a number of missing network coded packets may be to be reported for at least one unrecovered network coding generation.

In various embodiments, the status report request may indicate if a number of extra network coded packets may be to be reported for at least one recovered network coding generation. In various embodiments, the extra network coded packets may have been received in addition to network coded packets used for recovering the at least one recovered network coding generation.

In various embodiments, the status report request may indicate a characteristic for which a number of received network coded packets may be to be reported for the at least one network coding generation.

In various embodiments, the status report may indicate a number of missing network coded packets for recovering the at least one network coding generation.

In various embodiments, the at least one network coded packet may comprise at least one already transmitted network coded packet that may not have been indicated by the status report as missing.

In various embodiments, the status report may indicate a new network coding code rate.

In various embodiments, the method 1100 may further include updating a network coding code rate to the new network coding code rate and applying the new network coding code rate to any of the at least one network coding generation and a subsequent network coding generation.

In various embodiments, the method 1100 may further include receiving an indication that the at least one network coding generation may have been recovered and removing from a transmit buffer network coded packets associated with the at least one network coding generation.

In various embodiments, the method 1100 may further include receiving an indication that the at least one network coding generation may have been recovered and updating a lower edge of a transmitting window to be a first network coded packet generated using a next network coding generation to be recovered.

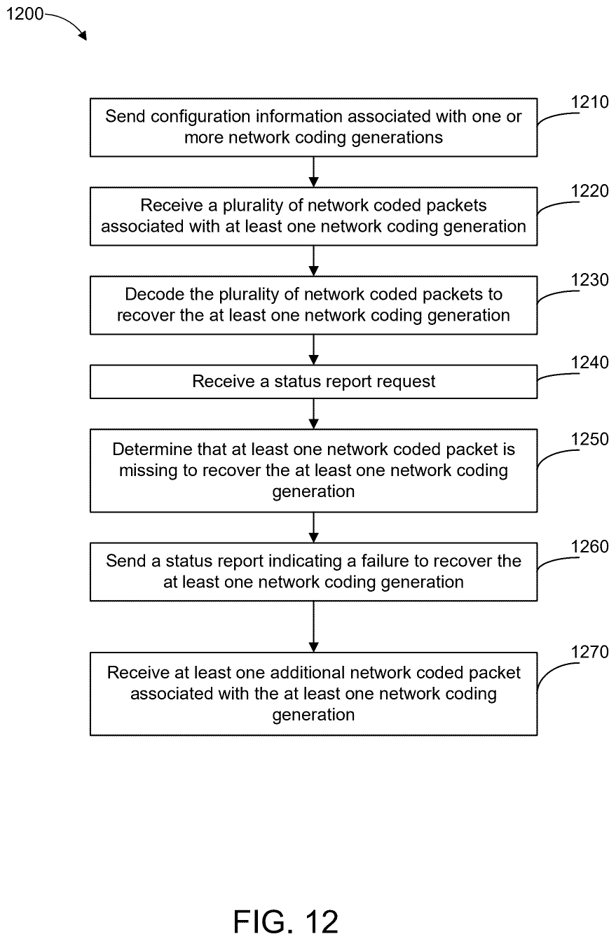

FIG. 12 is a diagram illustrating an example method 1200 for feedback management in presence of network coding, implemented in a network element. The network element may include circuitry including any of transmitter, a receiver, a processor, and a memory. The circuitry may be configured to carry out the method 1200. As shown at 1210, the method 1200 may include sending configuration information associated with one or more network coding generations. shown at 1220, the method 1200 may include receiving a plurality of network coded packets associated with at least one network coding generation. As shown at 1230, the method 1200 may include decoding the plurality of network coded packets to recover the at least one network coding generation. As shown at 1240, the method 1200 may include receiving a status report request. As shown at 1250, the method 1200 may include determining that at least one network coded packet may be missing to recover the at least one network coding generation. As shown at 1260, the method 1200 may include sending a status report indicating a failure to recover the at least one network coding generation. As shown at 1270, the method 1200 may include receiving at least one additional network coded packet associated with the at least one network coding generation. In various embodiments, the at least one additional network coded packet may not be a retransmission of a missing network coded packet.

In various embodiments, the configuration information may indicate any of (i) a network coding code rate, (ii) a number of network coded packets to be used to recover a network coding generation, (iii) a maximum number of transmissions of network coded packets per network coding generation, and (iv) a number of network coding generations between triggers of status report requests.

In various embodiments, the maximum number of transmissions of network coded packets may comprise any of a maximum number of retransmissions of network coded packets and a maximum number of transmissions of additional network coded packets.

In various embodiments the status report request may indicate the at least one network coding generation for which information may be to be included in the status report.

In various embodiments, the status report request may indicate that a number of missing network coded packets may be to be reported for at least one unrecovered network coding generation.

In various embodiments, the status report may indicate a number of missing network coded packets to be received for recovering the at least one network coding generation.

In various embodiments, the status report may indicate a new network coding code rate.

In various embodiments, the network element may comprise a base station.

The content of each of the following references is incorporated by reference herein in its entirety:
3GPP Technical Specification TS 38.322 “NR; Radio Link Control (RLC) protocol specification”, v18.1.0, June 2024;
3GPP 38.323 “NR; Packet Data Convergence Protocol (PDCP) specification”, v18.1.0, March 2024.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and a memory, the circuitry being operable (e.g., configured) to process the disclosed method, with a computer program product comprising program code instructions and with a non-transitory computer-readable storage medium storing program instructions. Besides, any characteristic, variant or embodiment described for a WTRU is compatible with a network element such as e.g., a base station.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A wireless transmit/receive unit (WTRU) comprising circuitry, including any of a transmitter, a receiver, a processor, and a memory, configured to:
receive configuration information associated with one or more network coding generations;
determine that at least one condition to trigger a status report request is satisfied for at least one network coding generation;
send the status report request based on the at least one condition being satisfied for the at least one network coding generation;
receive a status report comprising information associated with the at least one network coding generation; and
transmit at least one network coded packet generated using the at least one network coding generation based on the status report and the configuration information, wherein the at least one network coded packet comprises at least one additional network coded packet to be transmitted for the at least one network coding generation.

2. The WTRU of claim 1, wherein a network coding generation comprises a set of source packets being coded together.

3. The WTRU of claim 1, wherein the configuration information indicates any of (i) a network coding code rate, (ii) a number of network coded packets to be used to recover a network coding generation, (iii) a maximum number of transmissions of network coded packets per network coding generation, and (iv) a number of network coding generations between triggers of status report requests.

4. The WTRU of claim 3, wherein the maximum number of transmissions of network coded packets comprises any of a maximum number of retransmissions of network coded packets and a maximum number of transmissions of additional network coded packets.

5. The WTRU of claim 1, wherein the at least one condition to trigger the status report request is satisfied in a case where a number of network coding generations transmitted since a previous status report has been requested, is above a threshold.

6. The WTRU of claim 1, wherein the at least one condition to trigger the status report request is satisfied in a case where all network coded packets generated using the one or more network coding generations have been transmitted.

7. The WTRU of claim 1, wherein the at least one condition to trigger the status report request is satisfied in a case where a delay budget for the at least one network coding generation is less than a time bound.

8. The WTRU of claim 1, wherein the status report request indicates the at least one network coding generation for which information is to be included in the status report.

9. The WTRU of claim 1, wherein the status report request indicates if a number of missing network coded packets is to be reported for at least one unrecovered network coding generation.

10. The WTRU of claim 1, wherein the status report request indicates if a number of extra network coded packets is to be reported for at least one recovered network coding generation, wherein the extra network coded packets have been received in addition to network coded packets used for recovering the at least one recovered network coding generation.

11. The WTRU of claim 1, wherein the status report request indicates a characteristic for which a number of received network coded packets is to be reported for the at least one network coding generation.

12. The WTRU of claim 1, wherein the status report indicates a number of missing network coded packets for recovering the at least one network coding generation.

13. The WTRU of claim 1, wherein the at least one network coded packet comprises at least one already transmitted network coded packet that has not been indicated by the status report as missing.

14. The WTRU of claim 1, wherein the status report indicates a new network coding code rate.

15. The WTRU of claim 14, further configured to update a network coding code rate to the new network coding code rate and to apply the new network coding code rate to any of the at least one network coding generation and a subsequent network coding generation.

16. The WTRU of claim 1, further configured to:
receive an indication that the at least one network coding generation has been recovered; and
remove from a transmit buffer network coded packets associated with the at least one network coding generation.

17. The WTRU of claim 1, further configured to:
receive an indication that the at least one network coding generation has been recovered; and
update a lower edge of a transmitting window to be a first network coded packet generated using a next network coding generation to be recovered.

18. A method implemented in a wireless transmit/receive unit (WTRU), the method comprising:
receiving configuration information associated with one or more network coding generations;
determining that at least one condition to trigger a status report request is satisfied for at least one network coding generation;
sending the status report request based on the at least one condition being satisfied for the at least one network coding generation;
receiving a status report comprising information associated with the at least one network coding generation; and
transmitting at least one network coded packet from the at least one network coding generation based on the status report and the configuration information, wherein the at least one network coded packet comprises at least one additional network coded packet to be transmitted for the at least one network coding generation.

19. The method of claim 18, wherein a network coding generation comprises a set of source packets being coded together.

20. A network element comprising circuitry, including any of a transmitter, a receiver, a processor, and a memory, configured to:
send configuration information associated with one or more network coding generations;
receive a plurality of network coded packets associated with at least one network coding generation;
decode the plurality of network coded packets to recover the at least one network coding generation;
receive a status report request;
determine that at least one network coded packet is missing to recover the at least one network coding generation;
send a status report indicating a failure to recover the at least one network coding generation; and
receive at least one additional network coded packet associated with the at least one network coding generation, wherein the at least one additional network coded packet is not a retransmission of a missing network coded packet.
